(19) United States
(12) Patent Application Publication
(10) Pub. No.: US 2024/0319928 A1
(43) Pub. Date: Sep. 26, 2024

(54) RELAY SERVER, PRINTING SYSTEM, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Yasuhiro FURUTA, SHIMOSUWA-MACHI (JP)

(21) Appl. No.: 18/611,842

(22) Filed: Mar. 21, 2024

(30) Foreign Application Priority Data
Mar. 24, 2023 (JP) 2023-047703

(51) Int. Cl. G06F 3/12

(52) U.S. Cl. CPC G06F 3/1204; G06F 3/1211; G06F 3/1238; G06F 3/1288

(57) ABSTRACT

A relay server according to the present disclosure is a relay server coupled to a first printing service system and a second printing service system coupled to an image forming device. The relay server includes: a registration reception unit configured to acquire a registration instruction for the image forming device; an information acquisition unit configured to acquire information on the image forming device from the second printing service system when the registration instruction is acquired; and a registration setting unit configured to register the image forming device in the first printing service system using the information on the image forming device acquired from the second printing service system, and to instruct the first printing service system to create client automatic setting information for registering the image forming device in a terminal device of a user.

The present application is based on, and claims priority from JP Application Serial Number 2023-047703, filed Mar. 24, 2023, the disclosure of which is hereby incorporated by reference herein in its entirety.

### BACKGROUND

### 1. Technical Field

The present disclosure relates to a relay server, a printing system, an information processing method, and a non-transitory computer-readable storage medium storing a program.

### 2. Related Art

There has been a printing system implemented by combining different systems on a network. For example, JP-A-2022-038375 discloses a printing system implemented by combining a first cloud printing service system and a second cloud printing service system. The printing system further includes a cloud printing management service system that serves as a bridge between the first cloud printing service system and the second cloud printing service system. The cloud printing management service system associates a virtual printer registered in the first cloud printing service system with a printing device registered in the second cloud printing service system, thereby enabling printing performed by the printing device via the first cloud printing service system and the second cloud printing service system.

JP-A-2022-038375 is an example of the related art.

### SUMMARY

In the technique disclosed in JP-A-2022-038375, the cloud printing management service system registers an image forming device in the first cloud printing service system. When a user uses the image forming device, it is necessary to register the image forming device also in a terminal device used by the user. However, in the technique disclosed in JP-A-2022-038375, it is necessary to manually register the image forming device in the terminal device used by the user, and registration of the image forming device becomes complicated.

A relay server according to an aspect of the present disclosure is a relay server coupled to a first printing service system and a second printing service system coupled to an image forming device. The relay server includes: a registration reception unit configured to acquire a registration instruction for the image forming device; an information acquisition unit configured to acquire information on the image forming device from the second printing service system when the registration instruction is acquired; and a registration setting unit configured to register the image forming device in the first printing service system using the information on the image forming device acquired from the second printing service system, and to instruct the first printing service system to create client automatic setting information for registering the image forming device in a terminal device of a user.

A printing system according to an aspect of the present disclosure includes: a first printing service system; an image forming device; a second printing service system coupled to the image forming device; a terminal device coupled to the first printing service system; and a relay server coupled to the first printing service system and the second printing service system. The relay server includes a registration reception unit configured to acquire a registration instruction for the image forming device, an information acquisition unit configured to acquire information on the image forming device from the second printing service system when the registration instruction is acquired, and a registration setting unit configured to register the image forming device in the first printing service system using the information on the image forming device acquired from the second printing service system, and to instruct the first printing service system to create client automatic setting information for registering the image forming device in the terminal device. The first printing service system transmits the client automatic setting information to the terminal device in response to a request from the terminal device, and the terminal device registers the image forming device in the terminal device using the client automatic setting information.

An information processing method according to an aspect of the present disclosure includes: by a relay server coupled to a first printing service system and a second printing service system coupled to an image forming device, acquiring a registration instruction for the image forming device; acquiring information on the image forming device from the second printing service system when the registration instruction is acquired; and registering the image forming device in the first printing service system using the information on the image forming device acquired from the second printing service system, and instructing the first printing service system to create client automatic setting information for registering the image forming device in a terminal device of a user.

A program according to an aspect of the present disclosure is a non-transitory computer-readable storage medium storing a program, the program causing a computer of a relay server coupled to a first printing service system and a second printing service system coupled to an image forming device to execute operations including: acquiring a registration instruction for the image forming device; acquiring information on the image forming device from the second printing service system when the registration instruction is acquired; and registering the image forming device in the first printing service system using the information on the image forming device acquired from the second printing service system, and instructing the first printing service system to create client automatic setting information for registering the image forming device in a terminal device of a user.

### BRIEF DESCRIPTION OF THE DRAWINGS

FIG. 1 is a block diagram showing an example of a configuration of a printing system according to an embodiment.

FIG. 2 is a block diagram showing an example of a configuration of a first printing service system according to the embodiment.

FIG. 3 is a block diagram showing an example of a configuration of a second printing service system according to the embodiment.

FIG. 4 is a block diagram showing an example of a configuration of a relay server according to the embodiment.

FIG. 5 is a block diagram showing an example of a configuration of a terminal device according to the embodiment.

FIG. 6 is a block diagram showing an example of a configuration of an image forming device according to the embodiment.

FIG. 7 is a sequence chart showing an example of a flow of a qualification information storage process.

FIG. 8 is a sequence chart showing an example of a flow of a qualification information updating process.

FIG. 9A is a sequence chart showing an example of a flow of a personal printer registration process.

FIG. 9B is a sequence chart showing an example of the flow of the personal printer registration process.

FIG. 9C is a sequence chart showing an example of the flow of the personal printer registration process.

FIG. 9D is a sequence chart showing an example of the flow of the personal printer registration process.

FIG. 10A is a sequence chart showing an example of a flow of a shared printer registration process.

FIG. 10B is a sequence chart showing an example of the flow of the shared printer registration process.

FIG. 10C is a sequence chart showing an example of the flow of the shared printer registration process.

FIG. 10D is a sequence chart showing an example of the flow of the shared printer registration process.

FIG. 10E is a sequence chart showing an example of the flow of the shared printer registration process.

FIG. 11 is a sequence chart showing an example of a flow of a process of registering a printer in the terminal device.

FIG. 12 is a sequence chart showing an example of a flow of a process of deleting client automatic setting information from the first printing service system.

FIG. 13A is a sequence chart showing an example of a flow of a printing process.

FIG. 13B is a sequence chart showing an example of the flow of the printing process.

FIG. 13C is a sequence chart showing an example of the flow of the printing process.

FIG. 14 is a sequence chart showing an example of the flow of the printing process, in particular, a sequence chart showing an example of a notification process executed every time a job state changes.

### DESCRIPTION OF EMBODIMENTS

Hereinafter, embodiments will be described with reference to the drawings. To clarify the description, the following description and drawings are omitted and simplified as appropriate. In the drawings, the same elements are denoted by the same reference signs, and redundant description thereof is omitted as necessary.

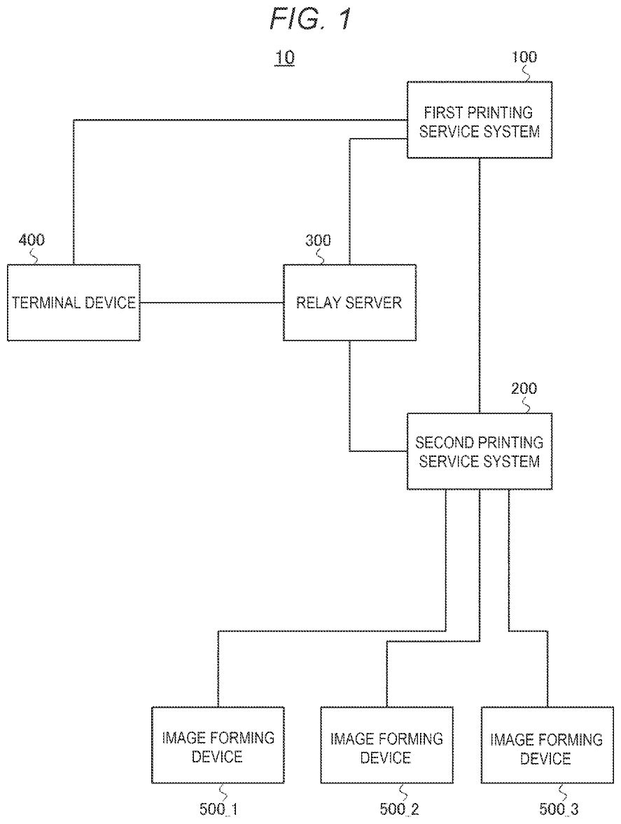

FIG. 1 is a block diagram showing an example of a configuration of a printing system 10 according to an embodiment. The printing system 10 includes a first printing service system 100, a second printing service system 200, and a relay server 300. FIG. 1 also shows a terminal device 400 and image forming devices 500_1, 500_2, and 500_3 that are communicably connected to the printing system 10.

In the following description, the image forming devices 500_1, 500_2, and 500_3 are referred to as image forming devices 500 when they are not particularly distinguished. A system including the terminal device 400 may be referred to as the printing system 10. Similarly, a system including the image forming device 500 may be referred to as the printing system 10.

The first printing service system 100 and the second printing service system 200 are systems that provide printing services on a cloud. Here, the first printing service system 100 is a system for services provided by a first vendor, and the second printing service system 200 is a system for services provided by a second vendor different from the first vendor. For example, the second vendor is a vendor that produces the image forming device 500. The image forming device 500 is a device having a function of performing a printing process. In the embodiment, specifically, the image forming device 500 is a printer. In the embodiment, the image forming device 500 is registered in the second printing service system 200 in advance as a device capable of executing a printing process for a printing job managed by the second printing service system 200. The terminal device 400 is client terminals such as personal computers (PCs), smartphones, and tablet terminals. The relay server 300 is a server that bridges the first printing service system 100 and the second printing service system 200, and relays a process in the printing system 10.

As shown in FIG. 1, the first printing service system 100 and the second printing service system 200 are communicably connected to each other. The relay server 300 is communicably connected to each of the first printing service system 100 and the second printing service system 200. The image forming device 500 is communicably connected to the second printing service system 200. The terminal device 400 is communicably connected to at least the first printing service system 100 and the relay server 300. In addition to the above-described connection relationship, a further connection relationship may be present between the components. For example, the terminal device 400 may be communicably connected to the second printing service system 200. In FIG. 1, three image forming devices 500 are shown as an example, and the number of image forming devices 500 using the printing system 10 is any value. Similarly, one terminal device 400 is shown as an example, but the number of terminal devices 400 using the printing system 10 is any value.

As described above, both the first printing service system 100 and the second printing service system 200 are systems that provide printing services on a cloud. Therefore, when a printer is registered in the printing service system, the printer can perform printing via the printing service system. For example, printing based on an instruction from the terminal device 400 can be implemented by a printer registered in the printing service system. However, when the printer is not a model that supports a protocol used by the printing service system, the printer cannot be directly registered in the printing service system. In the embodiment, the image forming device 500 supports a protocol used by the second printing service system 200, and can be directly registered in the second printing service system 200. However, the image forming device 500 does not necessarily support a protocol used by the first printing service system 100.

Therefore, in the embodiment, a printer registered as a virtual printer (virtual device) in the first printing service system 100 is associated with the image forming device 500 registered in the second printing service system 200, thereby enabling printing by the image forming device 500 via the first printing service system 100. The association is performed by the relay server 300. That is, by using the relay server 300, the image forming device 500 is substantially registered in the first printing service system 100. Although the image forming device 500 owned by a user at home is a model that does not support the protocol of the first printing service system 100, the user may desire printing performed by the image forming device 500 using the printing service provided by the first printing service system 100. Examples of such a case include a case in which installation of a printer driver of the image forming device 500 required in the second printing service system 200 is not required in the first printing service system 100. Of course, the user may desire printing performed by the image forming device 500 using the first printing service system 100 for any other reason. In such a case, it is substantially necessary to register the image forming device 500 in the first printing service system 100 by using the relay server 300. The first printing service system 100 provides a printing service using, for example, internet printing protocol shared infrastructure extensions (IPP-Infra) as the above-described protocol, whereas the second printing service system 200 provides a printing service without using the protocol.

In the embodiment, the relay server 300 acquires information on the image forming device 500 from the second printing service system 200 when registering the image forming device 500 in the first printing service system 100. The relay server 300 registers the image forming device 500 in the first printing service system 100 using information on the image forming device 500 acquired from the second printing service system 200, and instructs the first printing service system 100 to create client automatic setting information for registering the image forming device 500 in the terminal device 400. The client automatic setting information is information required for registering the image forming device 500 in the terminal device 400 of the user, and the terminal device 400 of the user can automatically register the image forming device 500 in the terminal device 400 by acquiring the client automatic setting information from the first printing service system 100. Therefore, it is possible to facilitate registration of the image forming device 500 in the terminal device 400.

For example, the client automatic setting information includes access right information that defines a user who can access the image forming device 500. The terminal device 400 may acquire the client automatic setting information from the first printing service system 100 when the user logs in the terminal device 400, and may automatically register the image forming device in the terminal device 400 when the user who logs in the terminal device 400 is included in the access right information in the client automatic setting information.

The relay server 300 may be configured to transmit, to the first printing service system 100, an instruction to delete the client automatic setting information stored in the first printing service system 100. That is, when an amount of the client automatic setting information stored in the first printing service system 100 increases, a load of the first printing service system 100 increases, and performance of the first printing service system 100 may decrease. In the embodiment, in consideration of this point, an instruction to delete the client automatic setting information stored in the first printing service system 100 may be transmitted from the relay server 300 to the first printing service system 100.

For example, the relay server 300 may set a schedule such that the client automatic setting information stored in the first printing service system 100 is deleted after a certain period of time elapses, and may transmit, based on the schedule, an instruction to delete the client automatic setting information to the first printing service system 100. The relay server 300 may be configured to acquire, from the first printing service system 100, identification information for specifying the client automatic setting information created by the first printing service system 100. In this case, the relay server 300 may transmit, to the first printing service system 100, the identification information when transmitting an instruction to delete the client automatic setting information.

Next, configurations of the first printing service system 100, the second printing service system 200, the relay server 300, the terminal device 400, and the image forming device 500 will be described.

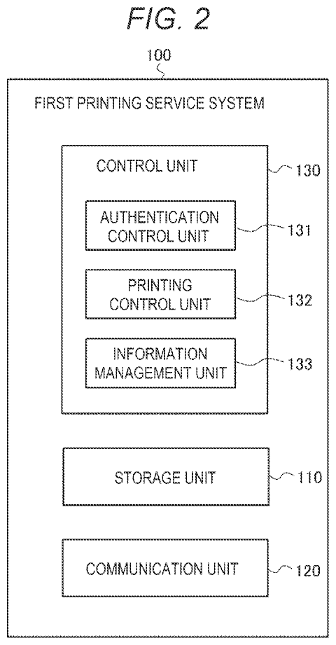

FIG. 2 is a block diagram showing an example of the configuration of the first printing service system 100. In the example shown in FIG. 2, the first printing service system 100 is implemented by one server, and the first printing service system 100 may be implemented by a plurality of servers.

As shown in FIG. 2, the first printing service system 100 includes a storage unit 110, a communication unit 120, and a control unit 130.

The storage unit 110 is a storage device that stores a program for implementing a process performed by the control unit 130 and data used for a process performed by the first printing service system 100. The storage device may be a nonvolatile storage device such as a hard disk or a flash memory, or may include a memory such as a random access memory (RAM). The storage unit 110 may also include a database. The communication unit 120 is a communication interface for communicating with other devices such as the second printing service system 200, the relay server 300, and the terminal device 400 via a wireless network or a wired network. The control unit 130 is a processor such as a central processing unit (CPU) that controls the components of the first printing service system 100. The control unit 130 may include a plurality of processors. The control unit 130 reads a program into the memory and executes the program. Accordingly, the control unit 130 implements functions of an authentication control unit 131, a printing control unit 132, and an information management unit 133.

The authentication control unit 131 performs various processes related to authentication of a user who uses the first printing service system 100. The user of the first printing service system 100 includes a user who is an administrator and a user who is a general user not an administrator. The user who is an administrator can also be referred to as a user who has administrator authority. The user who is a general user may be referred to as a user who has user authority that is authority more limited than the administrator authority. In the embodiment, it is assumed that a user is registered in advance in the first printing service system 100. The authentication control unit 131 provides a page for authentication to a Web browser 451 to be described later, performs authentication of an administrator or a general user, and issues a token required for accessing predetermined information managed by the first printing service system 100. A specific process performed by the authentication control unit 131 in the embodiment will be described using a sequence chart to be described later.

The printing control unit 132 performs a control process for executing printing by the printer registered in the first printing service system 100. In the embodiment, the printing control unit 132 performs a control process for performing printing by the image forming device 500 corresponding to the virtual printer registered in the first printing service system 100, and the printing control unit 132 may perform a control process for performing printing by a physical printer registered directly, not as a virtual printer, in the first printing service system 100. Specifically, in the embodiment, the printing control unit 132 performs a process of receiving a printing request from the terminal device 400, a process of transmitting, to the relay server 300, information required for performing printing according to the printing request, and a process of notifying the terminal device 400 of a job state and a printer state. A specific process performed by the printing control unit 132 in the embodiment will be described using a sequence chart to be described later.

The information management unit 133 performs a process of registering a printer for the first printing service system 100. The information management unit 133 manages information related to a user registered in the first printing service system 100 and information related to a printer registered in the first printing service system 100. In particular, the information management unit 133 manages, as the information related to the registered printer, a printer name, a printer ID, capability information, and shared information on the printer. Each of various types of information related to the printer is also referred to as attribute information. The information management unit 133 may further perform a process of registering a user in the first printing service system 100.

The information management unit 133 of the first printing service system 100 creates client automatic setting information for registering the image forming device 500 in the terminal device 400 of the user. The client automatic setting information created by the information management unit 133 is stored in the storage unit 110. The information management unit 133 transmits the client automatic setting information to the terminal device 400 in response to a request from the terminal device 400. For example, the client automatic setting information includes access right information that defines a user who can access the image forming device 500.

A specific process performed by the information management unit 133 in the embodiment will be described using a sequence chart to be described later.

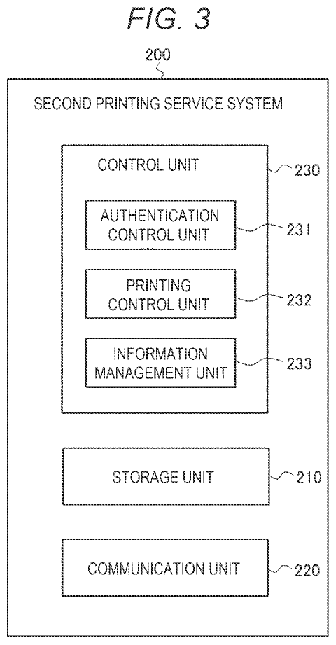

FIG. 3 is a block diagram showing an example of a configuration of the second printing service system 200. In the example shown in FIG. 3, the second printing service system 200 is implemented by one server, and the second printing service system 200 may be implemented by a plurality of servers.

As shown in FIG. 3, the second printing service system 200 includes a storage unit 210, a communication unit 220, and a control unit 230.

The storage unit 210 is a storage device that stores a program for implementing a process performed by the control unit 230 and data used for a process performed by the second printing service system 200. The storage device may be a nonvolatile storage device such as a hard disk or a flash memory, and may include a memory such as a RAM. The storage unit 210 may also include a database. The communication unit 220 is a communication interface for communicating with other devices such as the first printing service system 100, the relay server 300, and the image forming device 500 via a wireless network or a wired network. The control unit 230 is a processor, such as a CPU, that controls components of the second printing service system 200. The control unit 230 may include a plurality of processors. The control unit 230 reads a program into the memory and executes the program. Accordingly, the control unit 230 implements functions of an authentication control unit 231, a printing control unit 232, and an information management unit 233.

The authentication control unit 231 performs various processes related to authentication. For example, the authentication control unit 231 performs a process related to authentication of a printer registered in the second printing service system 200 and a process of issuing a token required for accessing predetermined information managed by the second printing service system 200. A specific process performed by the authentication control unit 231 in the embodiment will be described using a sequence chart to be described later.

The printing control unit 232 performs a control process for executing printing by the image forming device 500 that is a printer registered in the second printing service system 200. Specifically, in the embodiment, the printing control unit 232 performs a process of receiving a printing request from the relay server 300, a process of transmitting information required for printing according to the printing request to the image forming device 500, a process of notifying the relay server 300 of a job state, and the like. A specific process performed by the printing control unit 232 in the embodiment will be described using a sequence chart to be described later.

The information management unit 233 manages information registered in the second printing service system 200. In particular, in the embodiment, the information management unit 233 manages information related to the image forming device 500 that is a printer registered in the second printing service system 200. In the embodiment, the information management unit 233 particularly manages attribute information such as a printer name and capability information on the registered image forming device 500 as information related to the image forming device 500, that is, information related to the printer. The information management unit 233 may perform a process of registering the image forming device 500 in the second printing service system 200. A specific process performed by the information management unit 233 in the embodiment will be described using a sequence chart to be described later.

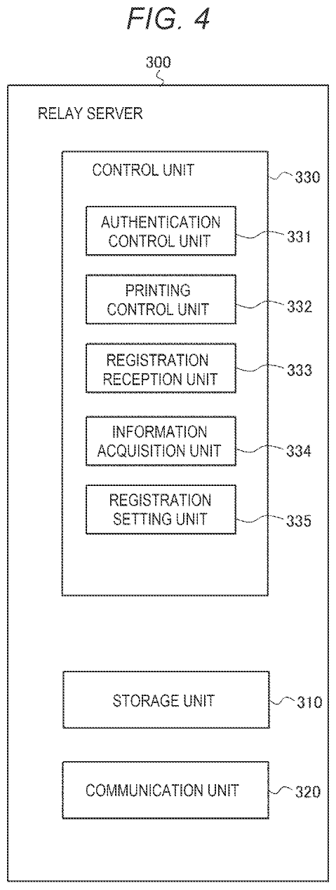

FIG. 4 is a block diagram showing an example of a configuration of the relay server 300. In the example shown in FIG. 4, the relay server 300 is implemented by one server, and the relay server 300 may be implemented by a plurality of servers. The relay server 300 may be referred to as a server.

As shown in FIG. 4, the relay server 300 includes a storage unit 310, a communication unit 320, and a control unit 330.

The storage unit 310 is a storage device that stores a program for implementing a process performed by the control unit 330 and data used for a process performed by the relay server 300. The storage device may be a nonvolatile storage device such as a hard disk or a flash memory, and may include a memory such as a RAM. The storage unit 310 may also include a database. The storage unit 310 stores, for example, an administrator access token and a refresh token, which are qualification information about the administrator, a correspondence relationship between a virtual printer and the image forming device 500, a correspondence relationship between a printing job in the first printing service system 100 and a printing job in the second printing service system 200, a registered user ID to be described later, and a client automatic setting information ID. The communication unit 320 is a communication interface for communicating with other devices such as the first printing service system 100, the second printing service system 200, and the terminal device 400 via a wireless network or a wired network. The control unit 330 is a processor, such as a CPU, that controls components of the relay server 300. The control unit 330 may include a plurality of processors. The control unit 330 reads a program into the memory and executes the program. Accordingly, the control unit 330 implements functions of an authentication control unit 331, a printing control unit 332, a registration reception unit 333, an information acquisition unit 334, and a registration setting unit 335.

The authentication control unit 331 performs various processes for receiving authentication by the first printing service system 100 and various processes for receiving authentication by the second printing service system 200. Specifically, the authentication control unit 331 performs a process of acquiring a token (administrator access token, refresh token) required for accessing predetermined information managed by the first printing service system 100 and a process of acquiring a token required for accessing predetermined information managed by the second printing service system 200. A specific process performed by the authentication control unit 331 in the embodiment will be described using a sequence chart to be described later.

The printing control unit 332 performs a control process for executing printing by the image forming device 500 that is a printer registered in the second printing service system 200, that is, the image forming device 500 that is a printer registered in the first printing service system 100 using a virtual printer. The printing control unit 332 performs a process of acquiring information required for printing from the first printing service system 100, a process of transmitting a printing request to the second printing service system 200 based on the information, a process of notifying the first printing service system 100 of a job state and a printer state, and the like. A specific process performed by the printing control unit 332 in the embodiment will be described using a sequence chart to be described later.

As to be described later with reference to the sequence chart, the printing control unit 332 has a function of acquiring, from the second printing service system 200, a job state regarding a printing process performed by the image forming device 500. As to be described later with reference to the sequence chart, the printing control unit 332 has a function of, when a job state is acquired from the second printing service system 200, transmitting the job state to the first printing service system 100, and a function of transmitting a state of the image forming device 500 to the first printing service system 100. Further, as to be described later with reference to the sequence chart, the printing control unit 332 has a function of determining a state of the image forming device 500 based on the job state acquired from the second printing service system 200.

The registration reception unit 333 performs a process of acquiring a registration instruction instructing to register the image forming device 500 in the first printing service system 100. A specific process performed by the registration reception unit 333 in the embodiment will be described with reference to a sequence chart to be described later.

The information acquisition unit 334 acquires user information from the first printing service system 100. In the embodiment, the information acquisition unit 334 acquires, for example, a user name that is a name of a user managed by the first printing service system 100 as user information. The information acquisition unit 334 performs a process of acquiring printer information, which is information on the image forming device 500, from the second printing service system 200. In the embodiment, the information acquisition unit 334 acquires, for example, a printer name that is a name of the image forming device 500 managed by the second printing service system 200 as information on the image forming device 500. A specific process performed by the information acquisition unit 334 in the embodiment will be described using a sequence chart to be described later.

The registration setting unit 335 performs a process of registering the image forming device 500 in the first printing service system 100. Specifically, the registration setting unit 335 registers the image forming device 500 in the first printing service system 100 by performing a process of registering a virtual printer associated with the image forming device 500 in the first printing service system 100. When the image forming device 500 is registered in the first printing service system 100, the registration setting unit 335 performs a process of setting information, the information being attribute information related to the image forming device 500 and managed by the first printing service system 100. In the embodiment, the first printing service system 100 performs a registration process only in response to a request for registration with administrator authority, and does not permit registration in response to a request for registration without administrator authority. In the embodiment, the first printing service system 100 performs a setting process for the attribute information only in response to a setting request with the administrator authority, and does not permit setting in response to a setting request without the administrator authority. Therefore, the registration setting unit 335 performs a process of registering the image forming device 500 in the first printing service system 100 using qualification information corresponding to the administrator authority.

Similarly, the registration setting unit 335 performs a process of setting attribute information managed by the first printing service system 100 using qualification information corresponding to the administrator authority. In particular, as to be described later, when the registration reception unit 333 acquires a registration instruction from a general user, the registration setting unit 335 performs the process using qualification information about the administrator stored in the storage unit 310 in advance.

The registration setting unit 335 may transmit, to the first printing service system 100, an instruction to delete the client automatic setting information stored in the first printing service system 100. For example, the registration setting unit 335 may set a schedule such that the client automatic setting information stored in the first printing service system 100 is deleted after a certain period of time elapses, and may transmit, based on the schedule, an instruction to delete the client automatic setting information to the first printing service system 100. The registration setting unit 335 may acquire, from the first printing service system 100, a client automatic setting information ID that is identification information for specifying the client automatic setting information created by the first printing service system 100. The registration setting unit 335 may transmit the client automatic setting information ID when transmitting an instruction to delete the client automatic setting information to the first printing service system 100. Accordingly, the first printing service system 100 can delete, from the client automatic setting information stored in the first printing service system 100, the client automatic setting information specified by the client automatic setting information ID. A specific process performed by the registration setting unit 335 in the embodiment will be described with reference to a sequence chart to be described later.

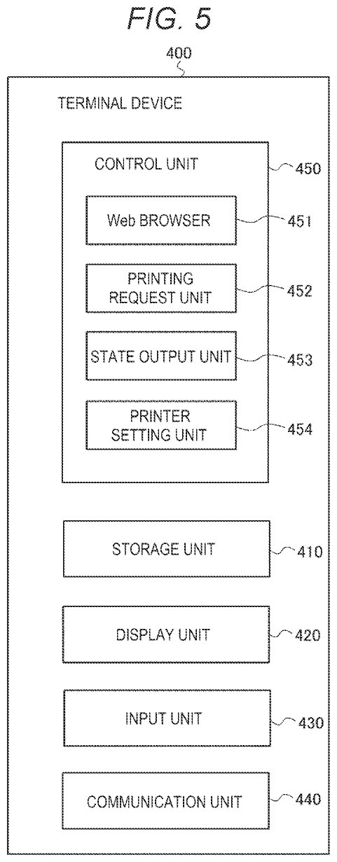

FIG. 5 is a block diagram showing an example of the configuration of the terminal device 400. As shown in FIG. 5, the terminal device 400 includes a storage unit 410, a display unit 420, an input unit 430, a communication unit 440, and a control unit 450.

The storage unit 410 is a storage device that stores a program for implementing a process of the control unit 450 and data used for a process of the terminal device 400. The storage device may be a nonvolatile storage device such as a hard disk or a flash memory, and may include a memory such as a RAM. The display unit 420 is a device for displaying information, and is, for example, a display such as a flat panel display. The input unit 430 is a device that receives an input operation from a user, and is, for example, a keyboard or a mouse. The display unit 420 and the input unit 430 may be integrally implemented by a touch panel or the like. The communication unit 440 is a communication interface for communicating with other devices such as the first printing service system 100 and the relay server 300 via a wireless network or a wired network. The control unit 450 is a processor such as a CPU that controls components of the terminal device 400. The control unit 450 may include a plurality of processors. The control unit 450 reads a program into the memory and executes the program. Accordingly, the control unit 450 implements functions of the Web browser 451, a printing request unit 452, a state output unit 453, and a printer setting unit 454.

The Web browser 451 is a known Web browser, and in the embodiment, performs a process of displaying a web page provided from the first printing service system 100 or the relay server 300 on the display unit 420, a process of transmitting input information for the displayed web page, and the like. A specific process performed by the Web browser 451 in the embodiment will be described with reference to a sequence chart to be described later.

The printing request unit 452 performs a process of requesting printing in response to an operation from the user. In the embodiment, in particular, the printing request unit 452 requests the first printing service system 100 to perform printing. A specific process performed by the printing request unit 452 in the embodiment will be described with reference to a sequence chart to be described later.

The state output unit 453 acquires a job state and a printer state to be described later via the first printing service system 100, and performs a process of outputting the job state and the printer state. In the embodiment, the state output unit 453 outputs the job state and the printer state to the display unit 420, but the output does not necessarily have to be performed by display. For example, the state output unit 453 may output the job state and the printer state by sound or the like. A specific process performed by the state output unit 453 in the embodiment will be described using a sequence chart to be described later.

The printer setting unit 454 acquires the client automatic setting information from the first printing service system 100, and registers the image forming device 500 in the terminal device 400 using the acquired client automatic setting information. Specifically, when the user logs in the terminal device 400, the printer setting unit 454 acquires the client automatic setting information from the first printing service system 100. The client automatic setting information includes access right information that defines a user who can access the image forming device 500. When the access right information in the client automatic setting information includes a user who logs in the terminal device 400, the printer setting unit 454 automatically registers the image forming device 500. For example, the printer setting unit 454 creates a print queue for a virtual printer registered in the first printing service system 100.

In the embodiment, since the printer setting unit 454 automatically registers the image forming device 500, it is easy to register the image forming device 500 in the terminal device 400. That is, the user does not need to manually register the image forming device 500 in the terminal device 400, and thus it is possible to prevent the registration of the image forming device 500 from becoming complicated. A specific process performed by the printer setting unit 454 according to the embodiment will be described using a sequence chart to be described later.

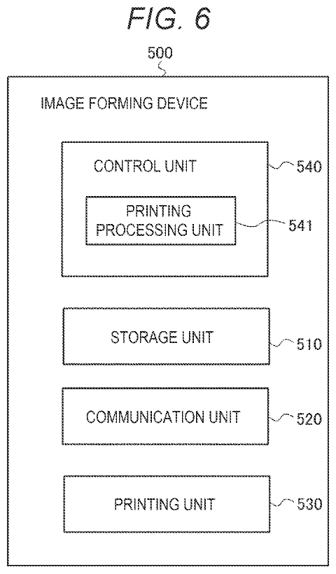

FIG. 6 is a block diagram showing an example of the configuration of the image forming device 500. As shown in FIG. 6, the image forming device 500 includes a storage unit 510, a communication unit 520, a printing unit 530, and a control unit 540.

The storage unit 510 is a storage device that stores a program for implementing a process of the control unit 540 and data used for a process of the image forming device 500. The storage device may be a nonvolatile storage device such as a hard disk or a flash memory, and may include a memory such as a RAM. The communication unit 520 is a communication interface for performing communication with other devices such as the second printing service system 200 via a wireless network or a wired network. The control unit 540 is a processor such as a CPU that controls components of the image forming device 500. The control unit 540 may include a plurality of processors. The control unit 540 reads a program into the memory and executes the program. Accordingly, the control unit 540 implements a function of a printing processing unit 541.

The printing processing unit 541 performs a process for executing printing by the printing unit 530. The printing processing unit 541 notifies the second printing service system 200 of a job state of a printing job. A specific process performed by the printing processing unit 541 in the embodiment will be described using a sequence chart to be described later.

The printing unit 530 has a printing function for forming an image on a printing medium such as a paper sheet. The printing unit 530 includes a printing engine. The printing engine is a mechanical configuration that prints an image on the printing medium using a color material. The printing engine may include a mechanism for printing using ink by, for example, an inkjet method. Alternatively, the printing engine may include a mechanism for printing using toner by, for example, electrophotography. The printing engine may include a conveyance mechanism that conveys the printing medium.

The image forming device 500 may further include a user interface such as a touch panel display. In the embodiment, as described above, the image forming device 500 includes the printing unit 530 and has a function of a printer. Therefore, the image forming device 500 is also referred to as a printer.

Next, a flow of a process performed by the printing system 10 will be described using a sequence chart.

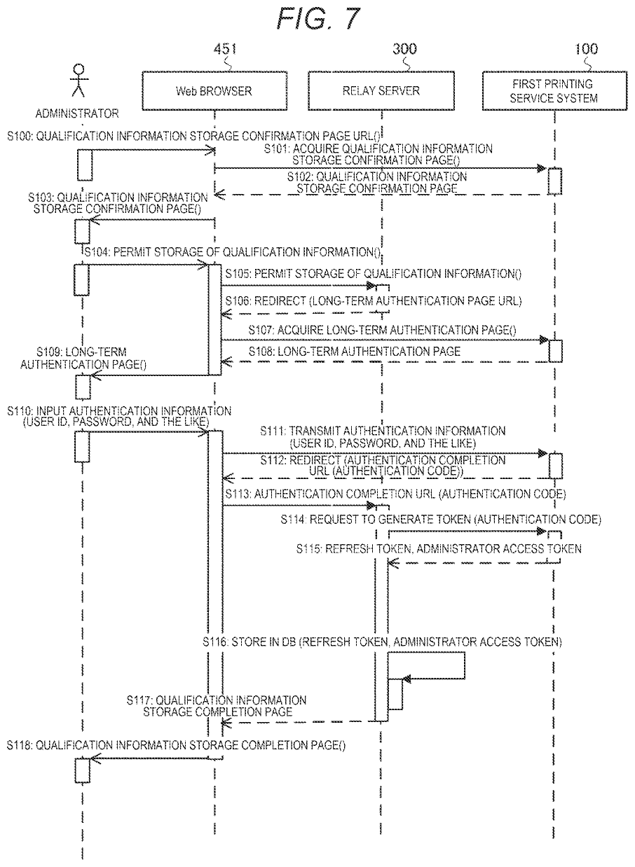

First, a flow of a process for storing, in the relay server 300, qualification information for permitting a predetermined request to the first printing service system 100 will be described. FIG. 7 is a sequence chart showing an example of a flow of a qualification information storage process executed in the printing system 10. An order of processes of steps in the sequence chart is merely an example, and can be appropriately changed as long as there is no technical contradiction. Hereinafter, the flow of the qualification information storage process will be described with reference to FIG. 7.

In step S100, an administrator registered in the first printing service system 100 performs a predetermined operation of requesting storage of qualification information via the input unit 430 of the terminal device 400. Accordingly, for example, a uniform resource locator (URL) for a qualification information storage confirmation page is input to the Web browser 451 of the terminal device 400. Here, the qualification information storage confirmation page is a page for confirming whether it is acceptable to store the qualification information. For example, the qualification information storage confirmation page may be a page including a button for instructing whether to store the qualification information. Since the storage of the qualification information leads to authority of the administrator being available for a long period of time, the printing system 10 inquires the user about an intention to store the qualification information by using the qualification information storage confirmation page, thereby confirming that the operation is not an erroneous operation by the user. After step S100, in step S101, the Web browser 451 transmits a request to acquire the qualification information storage confirmation page to the first printing service system 100 according to the input URL. In response to this, in step S102, the authentication control unit 131 of the first printing service system 100 transmits the qualification information storage confirmation page to the Web browser 451. Accordingly, in step S103, the Web browser 451 displays the qualification information storage confirmation page on the display unit 420 of the terminal device 400.

In the example shown in FIG. 7, a process is performed for confirming whether it is acceptable to store the qualification information, but this process may be omitted. In this case, an operation in step S104 to be described below corresponds to the operation of requesting storage of qualification information.

In step S104, the administrator inputs, to the qualification information storage confirmation page, an instruction to permit storage of the qualification information via the input unit 430. That is, the administrator inputs, to the Web browser 451, an instruction indicating that there is no error in the intention to store the qualification information. When such an instruction is input, in step S105, the Web browser 451 transmits, to the relay server 300, the instruction to permit storage of the qualification information. In response to this, in step S106, the authentication control unit 331 of the relay server 300 instructs the Web browser 451 to access a predetermined redirect page. In this step, the predetermined redirect page is a long-term authentication page. Therefore, the authentication control unit 331 of the relay server 300 transmits a URL of the long-term authentication page to the Web browser 451. The long-term authentication page is a page for requesting the user to input authentication information on the administrator when storing the qualification information for a long period of time. In step S107, the Web browser 451 transmits, according to the received URL, a request to acquire the long-term authentication page to the first printing service system 100. In response to this, in step S108, the authentication control unit 131 of the first printing service system 100 transmits the long-term authentication page to the Web browser 451. Accordingly, in step S109, the Web browser 451 displays the long-term authentication page on the display unit 420 of the terminal device 400.

In step S110, the administrator inputs authentication information to the long-term authentication page via the input unit 430. Specifically, the administrator in puts a user ID, a password, and the like of the administrator. Here, the required authentication information is authentication information used in the first printing service system 100, and specifically, is a user ID, a password, and the like registered in advance. In step S111, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches authentication information on the administrator that is registered in advance.

When the authentication is successful in the authentication process, that is, when the received authentication information matches the authentication information on the administrator registered in advance, in step S112, the authentication control unit 131 of the first printing service system 100 issues an authentication code, and further, instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S113, the Web browser 451 accesses the predetermined redirect destination together with the authentication code. Accordingly, the relay server 300 acquires the authentication code. In step S114, the authentication control unit 331 of the relay server 300 transmits, to the first printing service system 100, a request requesting generation of a token, together with the received authentication code. The authentication control unit 131 of the first printing service system 100 issues qualification information only when a request with a predetermined authentication code is received. In step S115, after confirming that the authentication code received in step S114 matches the authentication code transmitted in step S112, the authentication control unit 131 issues qualification information, and transmits the qualification information to the relay server 300. Specifically, the authentication control unit 131 issues an administrator access token and a refresh token, and transmits the administrator access token and the refresh token to the relay server 300. Accordingly, the authentication control unit 331 of the relay server 300 acquires the administrator access token and the refresh token.

The administrator access token is information certifying that the administrator has valid access. In the embodiment, more specifically, the administrator access token is information certifying that the administrator has valid access when accessing predetermined information managed by the first printing service system 100. A validity period of the administrator access token is limited to a predetermined short period. For example, the validity period of the administrator access token is about several hours from issuance. In the above description, the relay server 300 transmits the authentication code to have the administrator access token issued, and more specifically, the relay server 300 may further transmit authentication information called a client secret.

The refresh token is information for updating the administrator access token, and a validity period of the refresh token is a predetermined period longer than that of the administrator access token. For example, the validity period of the refresh token may be several days or may be an infinite period. As to be described later, a new administrator access token and a new refresh token are issued when a valid refresh token is transmitted to the first printing service system 100.

In the embodiment, the administrator access token and the refresh token are examples of the qualification information. The qualification information may refer to only one of the administrator access token and the refresh token. As described above, information directly required to access predetermined information managed by the first printing service system 100 is an administrator access token. Therefore, the qualification information may particularly refer to only the administrator access token. The validity period of the administrator access token is not necessarily limited to a short period. The validity period of the administrator access token may be an indefinite period. Further, when the validity period of the administrator access token is sufficiently long, the refresh token may not be used in the embodiment.

Description of the sequence chart in FIG. 7 will be continued. After step S115, in step S116, the authentication control unit 331 of the relay server 300 stores the qualification information acquired in step S115, that is, the refresh token and the administrator access token, in the database of the storage unit 310 and the like. Thus, the storage unit 310 stores the qualification information about the administrator, that is, a user having the administrator authority. Thereafter, in step S117, the authentication control unit 331 transmits a qualification information storage completion page to the Web browser 451. The qualification information storage completion page is a page for outputting a notification indicating that the qualification information is appropriately stored in the relay server 300. Accordingly, in step S118, the Web browser 451 displays the qualification information storage completion page on the display unit 420 of the terminal device 400.

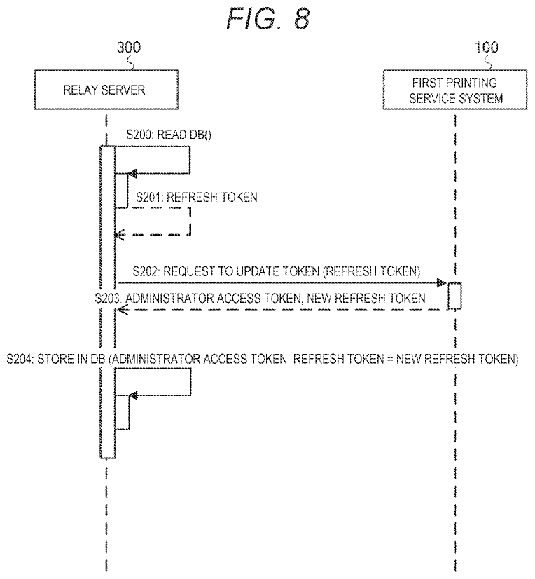

Next, a flow of a process for updating the qualification information held by the relay server 300 will be described. FIG. 8 is a sequence chart showing an example of a flow of a qualification information updating process executed in the printing system 10. The updating process shown in FIG. 8 is executed at a predetermined timing, for example. Specifically, this updating process may be performed to update the administrator access token when a printer registration process is executed, or may be performed periodically (for example, at intervals of one day) to update the refresh token. An order of processes of steps in the sequence chart is merely an example, and can be appropriately changed as long as there is no technical contradiction. Hereinafter, the flow of qualification information updating process will be described with reference to FIG. 8.

In step S200, the authentication control unit 331 of the relay server 300 performs a process of reading the database of the storage unit 310 and the like. Accordingly, in step S201, the authentication control unit 331 reads a currently held refresh token. Next, in step S202, the authentication control unit 331 transmits, to the first printing service system 100, a request requesting updating of a token together with the currently held refresh token.

The authentication control unit 131 of the first printing service system 100 updates the qualification information only when a request with a valid refresh token is received. In step S203, after confirming that the refresh token received in step S202 is valid, the authentication control unit 131 updates the qualification information, and transmits the updated qualification information to the relay server 300. Specifically, the authentication control unit 131 transmits the updated administrator access token and the refresh token to the relay server 300. Accordingly, the authentication control unit 331 of the relay server 300 newly acquires the administrator access token and the refresh token. After step S203, in step S204, the authentication control unit 331 of the relay server 300 stores the qualification information acquired in step S203, that is, the refresh token and the administrator access token, in the database of the storage unit 310 and the like.

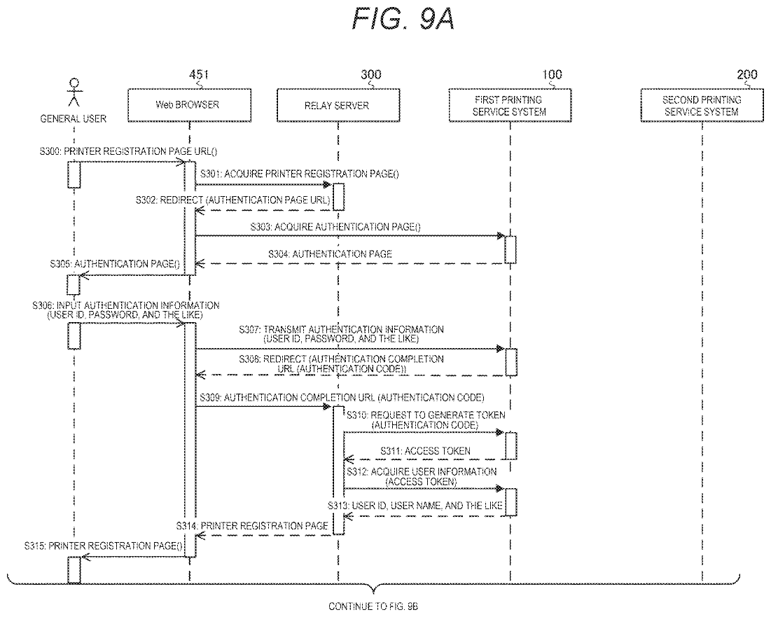

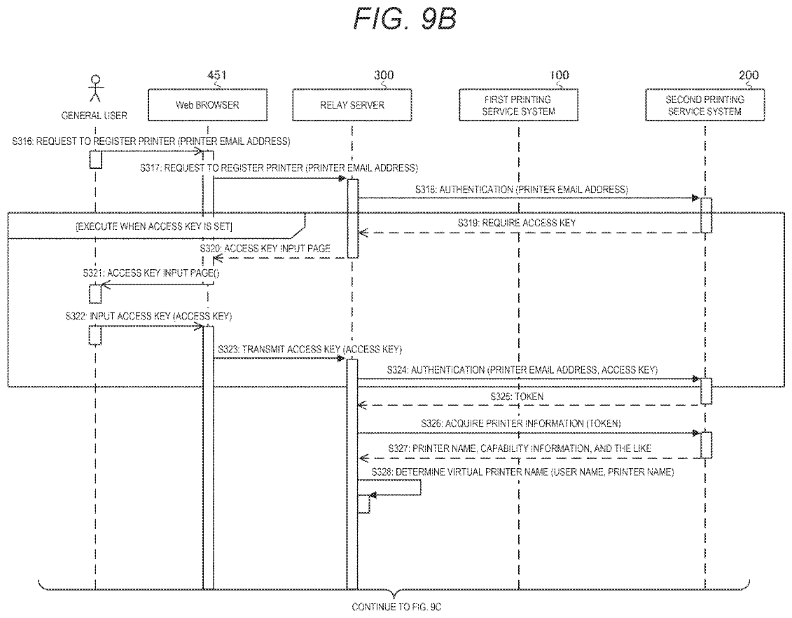

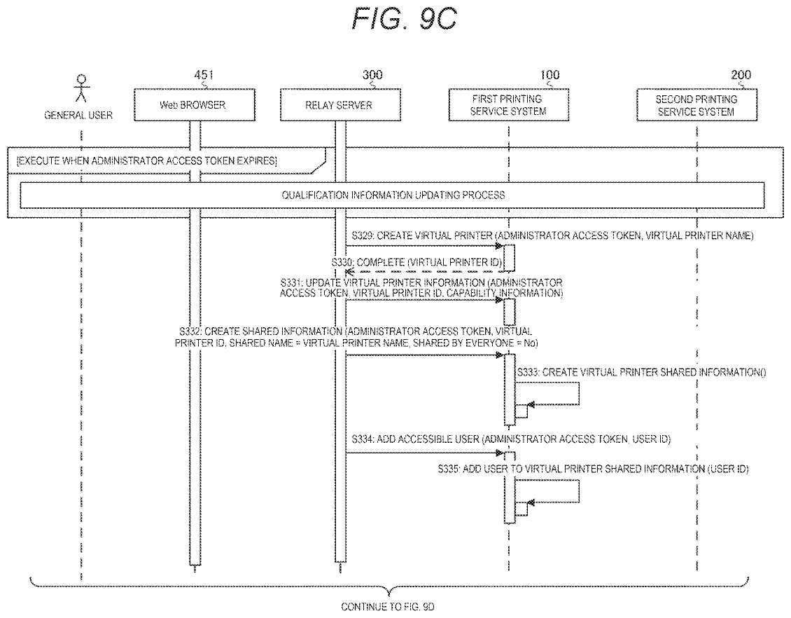

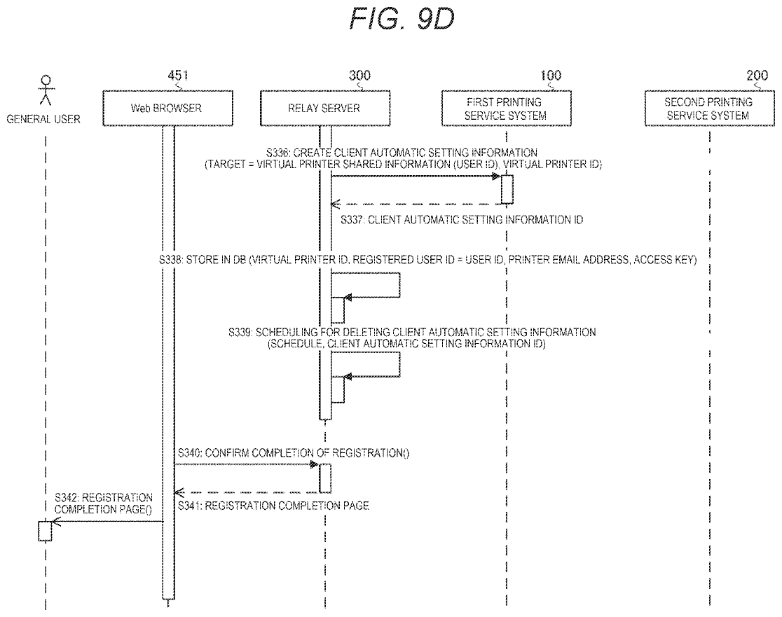

Next, a flow of a process for registering a personal printer in the first printing service system 100 will be described. FIGS. 9A to 9D are sequence charts showing an example of a flow of a personal printer registration process executed in the printing system 10. The personal printer is a printer that is assumed to be used by one specific user. Therefore, the personal printer can also be referred to as a printer that is scheduled to be used only by a user who performs a registration operation. That is, the personal printer is a printer that is not shared by a plurality of users. An order of processes of steps in the sequence chart is merely an example, and can be appropriately changed as long as there is no technical contradiction. The flow of the personal printer registration process is described below with reference to FIGS. 9A to 9D.

In step S300, a general user who is not the administrator performs, via the input unit 430 of the terminal device 400, a predetermined operation for starting the personal printer registration process. Accordingly, for example, a URL of the printer registration page is input to the Web browser 451 of the terminal device 400. Here, the printer registration page is a page prepared to register the personal printer in the first printing service system 100. After step S300, in step S301, the Web browser 451 transmits, to the relay server 300, a request to acquire the printer registration page according to the input URL. In response to this, in step S302, the registration reception unit 333 of the relay server 300 instructs the Web browser 451 to access a predetermined redirect page. In this step, the predetermined redirect page is an authentication page. Therefore, the registration reception unit 333 of the relay server 300 transmits a URL of the authentication page to the Web browser 451. The authentication page is a page for requesting the user to input authentication information when registering the printer. In step S303, the Web browser 451 transmits, according to the received URL, a request to acquire the authentication page to the first printing service system 100. In response to this, in step S304, the authentication control unit 131 of the first printing service system 100 transmits the authentication page to the Web browser 451. Accordingly, in step S305, the Web browser 451 displays the authentication page on the display unit 420 of the terminal device 400.

In step S306, the general user inputs authentication information to the authentication page via the input unit 430. Specifically, the general user inputs a user ID, a password, and the like of the user. Here, the required authentication information is authentication information used in the first printing service system 100, and specifically, is a user ID, a password, and the like registered in advance. In step S307, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches authentication information on the general user registered in advance.

When the authentication is successful in the authentication process, that is, when the received authentication information matches the authentication information on the general user registered in advance, in step S308, the authentication control unit 131 of the first printing service system 100 issues an authentication code, and further, instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S309, the Web browser 451 accesses the predetermined redirect destination together with the authentication code. Accordingly, the relay server 300 acquires the authentication code. In step S310, the authentication control unit 331 of the relay server 300 transmits, to the first printing service system 100, a request requesting generation of a token, together with the received authentication code. In step S311, after confirming that the authentication code received in step S310 matches the authentication code transmitted in step S308, the authentication control unit 131 of the first printing service system 100 issues an access token, and transmits the access token to the relay server 300. The access token is information certifying that the general user has valid access, and is referred to as a normal access token in the following description. Although the normal access token is also a type of the qualification information, when the information is used, access as the administrator is not permitted in the first printing service system 100. Therefore, in access using the normal access token, among information managed by the first printing service system 100, information that requires the administrator authority cannot be accessed. Meanwhile, in access using the normal access token, information that does not require administrator authority can be accessed. In the embodiment, the information acquisition unit 334 of the relay server 300 acquires, using the normal access token, user information on a general user who performs an operation for printer registration. Therefore, in step S312, the information acquisition unit 334 of the relay server 300 transmits, to the first printing service system 100, a request to acquire user information on a general user who performs an operation for printer registration, together with the normal access token acquired in step S311.

In response to this, in step S313, after confirming that the access token received in step S312 is valid, the information management unit 133 of the first printing service system 100 transmits user information on the general user to the relay server 300. Specifically, the information management unit 133 transmits, to the relay server 300, a user ID and a user name of the general user managed by the first printing service system 100. Accordingly, the information acquisition unit 334 of the relay server 300 acquires the user information. The information acquisition unit 334 of the relay server 300 may store the acquired user information in the storage unit 310 as necessary. Thereafter, in step S314, the registration reception unit 333 transmits a printer registration page to the Web browser 451. Accordingly, in step S315, the Web browser 451 displays the printer registration page on the display unit 420 of the terminal device 400.

In step S316, the general user performs, via the input unit 430 of the terminal device 400, a predetermined operation of requesting registration of the personal printer while designating a printer to be registered. Here, the printer to be registered is a printer to be newly available for printing via the first printing service system 100. In the embodiment, the printer to be registered is not a printer coupled to the first printing service system 100, but a printer coupled to the second printing service system 200, that is, the image forming device 500. This printer is registered in the first printing service system 100 by being associated with a virtual printer registered in the first printing service system 100. In step S316, more specifically, the general user inputs, to the printer registration page displayed in step S315, identification information that identifies the printer to be registered. For example, the general user inputs identification information on a personally owned printer. In the embodiment, as an example, the general user inputs an email address for the printer to be registered as the identification information. That is, the email address for the printer to be registered is input to the Web browser 451 of the terminal device 400. Any other information that can uniquely identify the printer to be registered may be used instead of the email address.

Next, in step S317, the Web browser 451 transmits, to the relay server 300, a request requesting registration of the printer in the first printing service system 100, together with the email address of the printer to be registered. Accordingly, the registration reception unit 333 acquires a registration instruction for the image forming device 500 from the general user. In response to this, in step S318, the authentication control unit 331 of the relay server 300 transmits the email address of the printer to be registered to the second printing service system 200 and requests authentication. When there is a printer corresponding to the email address and an access key such as a password is set in advance for the printer, processes from step S319 to step S324 to be described later are performed, and it is determined that the authentication is successful only when the access key is input. Meanwhile, when there is a printer corresponding to the email address and no access key is set for the printer, it is determined that the authentication is successful without performing the processes from steps S319 to S324 to be described later. A case where an access key is set to the printer specified by the email address is to be described below.

In step S319, the authentication control unit 231 of the second printing service system 200 requests the relay server 300 to transmit an access key. In response to this, in step S320, the authentication control unit 331 of the relay server 300 transmits, to the Web browser 451, an input page for receiving an input of the access key. Accordingly, in step S321, the Web browser 451 displays an access key input page on the display unit 420 of the terminal device 400. Next, in step S322, the general user inputs the access key to the input page via the input unit 430. In step S323, the Web browser 451 transmits the input access key to the relay server 300. In step S324, the authentication control unit 331 of the relay server 300 transmits the email address and the access key of the printer to be registered to the second printing service system 200, and requests authentication again. In response to this, the authentication control unit 231 of the second printing service system 200 performs authentication based on the information transmitted from the relay server 300.

When the authentication succeeds, in step S325, the authentication control unit 231 of the second printing service system 200 issues a token and transmits the token to the relay server 300. The token is an access token for accessing predetermined information managed by the second printing service system 200. In step S326, the information acquisition unit 334 of the relay server 300 that acquires the token transmitted from the second printing service system 200 transmits, to the second printing service system 200, a request to acquire printer information about the printer to be registered, together with the token acquired in step S325.

In response to this, in step S327, after confirming that the token received in step S326 is valid, the information management unit 233 of the second printing service system 200 transmits the printer information on the image forming device 500, which is the printer to be registered in the first printing service system 100, to the relay server 300. Specifically, the information management unit 233 transmits, to the relay server 300, a printer name and capability information on the printer managed by the second printing service system 200. The printer name is displayed to identify the printer when the user selects the printer. The capability information is information indicating printer capability, and can also be said to be information that specifies functions of the printer. The capability information may be, for example, information indicating whether double-sided printing is possible or information indicating whether color printing is possible. In this way, the information acquisition unit 334 of the relay server 300 acquires the printer information, that is, the information on the image forming device 500 from the second printing service system 200. The information acquisition unit 334 of the relay server 300 may store the acquired printer information in the storage unit 310 as necessary.

Next, in step S328, the registration setting unit 335 of the relay server 300 determines a printer name of a virtual printer to be registered in the first printing service system 100. As described above, the registration of the printer to be registered in the first printing service system 100 is implemented by registering the virtual printer associated with the printer to be registered. That is, in order to use the image forming device 500, which is a printer coupled to the second printing service system 200, via the first printing service system 100, a virtual printer associated with the printer coupled to the second printing service system 200 is registered in the first printing service system 100. That is, by registering a virtual printer associated with a physical printer coupled to the second printing service system 200 in the first printing service system 100, the physical printer is substantially registered in the first printing service system 100. The registration setting unit 335 determines a printer name of the virtual printer in order to register the virtual printer in the first printing service system 100. In this step, specifically, the registration setting unit 335 determines the printer name of the virtual printer using the user name acquired in step S313 and the printer name acquired in step S327. For example, the registration setting unit 335 determines the printer name of the virtual printer to include the acquired user name and printer name. The registration setting unit 335 may use only either one of the user name acquired in step S313 and the printer name acquired in step S327. In the determination of the printer name of the virtual printer, the registration setting unit 335 may receive an instruction from the user. For example, the registration setting unit 335 may create a plurality of candidates for the printer name, and the user may give an instruction to select one among the candidates. The user may instruct addition or deletion of a character string to or from the candidates for the printer name created by the registration setting unit 335.

Next, in step S329, a process using an administrator access token stored in advance is performed. When a validated date of the administrator access token expires, the qualification information updating process shown in FIG. 8 is performed to update the administrator access token. In step S329, the registration setting unit 335 of the relay server 300 uses the administrator access token to request the first printing service system 100 to register the virtual printer. Specifically, in step S329, the registration setting unit 335 transmits, to the first printing service system 100, a request requesting creation and registration of a virtual printer to be associated with the printer to be registered, together with the administrator access token. At this time, the registration setting unit 335 transmits the virtual printer name determined in step S328 together with the request. That is, the registration setting unit 335 requests registration of the virtual printer and setting of the virtual printer name.

As can be seen from steps S328 and S329, the registration setting unit 335 sets the virtual printer name, which is one of the attribute information managed by the first printing service system 100, using the information acquired from the second printing service system 200. Here, the virtual printer name managed by the first printing service system 100 corresponds to a name of the image forming device 500 managed by the first printing service system 100. Therefore, it can be said that the registration setting unit 335 sets the name of the image forming device 500 managed by the first printing service system 100 using the information acquired from the second printing service system 200. Thus, in the embodiment, since the attribute information managed by the first printing service system 100 is automatically set using the information acquired from the second printing service system 200, the attribute information can be easily set. In particular, in the embodiment, a printer name, which is a name of the image forming device 500 managed by the second printing service system 200, is used to set the name of the image forming device 500 managed by the first printing service system 100. Accordingly, since a printer name corresponding to the printer name used in the second printing service system 200 is used in the first printing service system 100, the user can easily specify the personal printer registered by the user when using the first printing service system 100. In particular, in the embodiment, the name of the image forming device 500 managed by the first printing service system 100 is set using a name of the general user who performs an operation for printer registration. Accordingly, when using the first printing service system 100, the user can easily specify the personal printer registered by the user.

Next, in step S330, the information management unit 133 of the first printing service system 100 determines a virtual printer ID as identification information for identifying the registered new virtual printer, and notifies the relay server 300 of registration completion of the virtual printer together with the virtual printer ID.

Thereafter, in steps S331 to S337, a setting process for the newly registered virtual printer is performed. Specifically, in step S331, the registration setting unit 335 of the relay server 300 transmits, to the first printing service system 100, a request to update capability information on the newly registered virtual printer, together with the administrator access token. At this time, the registration setting unit 335 transmits the virtual printer ID notified in step S330 and the capability information acquired in step S327 together with the request. In response to this, after confirming that the administrator access token received in step S331 is valid, the information management unit 133 of the first printing service system 100 updates the information on the virtual printer specified by the received virtual printer ID. Specifically, the information management unit 133 sets the received capability information as the capability information on the virtual printer specified by the received virtual printer ID. Accordingly, the created capability information on the virtual printer is updated. In this sequence chart, a request to set the capability information is transmitted in step S331, but a request to set the virtual printer name may be transmitted. That is, the virtual printer name determined in step S328 may be set in a step different from a virtual printer registration step. In this case, in step S329, the first printing service system 100 may not be notified of the virtual printer name, or may be notified of a default virtual printer name.

Thus, in the embodiment, in step S331, the registration setting unit 335 sets the capability information, which is one of the attribute information managed by the first printing service system 100, using the capability information, which is the information acquired from the second printing service system 200. Accordingly, since the attribute information managed by the first printing service system 100 is automatically set using the information acquired from the second printing service system 200, the attribute information can be easily set.

In steps S332 to S335, the registration setting unit 335 of the relay server 300 performs setting related to shared use of the newly registered virtual printer. That is, in steps S332 to S335, an access right to the printer is set. Here, the following specific processes are performed in order to perform the setting for using the printer to be registered as the personal printer.

In step S332, the registration setting unit 335 first performs a process for creating shared information. As described above, since it is necessary to prevent a user other than the general user who performs the operation for printer registration from using the printer to be registered, shared information that does not permit sharing by any user is created. More specifically, in step S332, the registration setting unit 335 transmits, to the first printing service system 100, a request to set the shared information on the newly registered virtual printer, together with the administrator access token. At this time, together with the request, the registration setting unit 335 also transmits the virtual printer ID notified in step S330 and an instruction designating that sharing by any user is not permitted. At this time, the registration setting unit 335 may transmit a shared name for identifying newly created shared information to the first printing service system 100. For example, the virtual printer name determined in step S328 may be used as such a shared name. The transmission of the shared name may be omitted. In response to this, in step S333, after confirming that the administrator access token received in step S332 is valid, the information management unit 133 of the first printing service system 100 creates, based on the received information, shared information on the virtual printer specified by the virtual printer ID. Specifically, the information management unit 133 creates shared information indicating that sharing by any user is not permitted.

In step S334, the registration setting unit 335 performs a process of correcting the shared information so that among general users, only the general user who performs the operation for printer registration can use the printer for which he or she performs the registration operation. In other words, the registration setting unit 335 corrects the shared information so that among the general users, only access from the general user who performs the operation for printer registration is permitted. Specifically, in step S334, the registration setting unit 335 transmits, to the first printing service system 100, a request to correct the shared information so as to permit use of the virtual printer by the general user who performs the operation for printer registration, together with the administrator access token. At this time, the registration setting unit 335 transmits the user ID acquired in step S313 as identification information on the general user who performs the operation for printer registration. In response to this, in step S335, after confirming that the administrator access token received in step S334 is valid, the information management unit 133 of the first printing service system 100 updates the shared information based on the received information. Specifically, the information management unit 133 adds a user having the received user ID to the shared information on the virtual printer.

Thus, in steps S332 to S335, the registration setting unit 335 sets the shared information corresponding to the access right of the printer to be registered. In other words, the registration setting unit 335 sets information that defines a user who can access the virtual printer, that is, a user who can access the image forming device 500 corresponding to the virtual printer. Accordingly, since the access right is automatically set, setting of the attribute information is easily implemented. In particular, in the embodiment, the registration setting unit 335 sets the shared information, that is, the attribute information on the printer so that among the general users, only the access from the general user who performs the operation for printer registration is permitted. Therefore, it is possible to prevent other users from using the printer. In particular, in the embodiment, as to be described later, the first printing service system 100 performs control so that only a printer to which a user has an access right is in options when the user designates a printer used for printing. Therefore, the user can easily select a usable printer when giving an instruction to print.

In the sequence chart shown here, the setting of the shared information is performed through the two steps, step S332 and step S334, but these processes may be performed in one step.

After step S335, in step S336, the registration setting unit 335 of the relay server 300 requests the first printing service system 100 to create client automatic setting information. Specifically, the registration setting unit 335 transmits, to the first printing service system 100, a request requesting generation of the client automatic setting information, together with the shared information on the virtual printer and the virtual printer ID notified in step S330. Here, the shared information on the virtual printer corresponds to the virtual printer shared information updated in step S335, and in this case is the user ID of the user who uses the personal printer.

The information management unit 133 of the first printing service system 100 creates the client automatic setting information and stores the client automatic setting information in the storage unit 110. The client automatic setting information created at this time includes the virtual printer name, the virtual printer ID, the capability information, and the virtual printer shared information. The virtual printer shared information corresponds to access right information that defines a user who can access the image forming device 500. The processes from FIGS. 9A to 9D are processes of registering the personal printer in the first printing service system 100, and in this case, the virtual printer shared information can be the user ID of the user who uses the personal printer.

The information management unit 133 of the first printing service system 100 generates a client automatic setting information ID that is identification information for specifying the client automatic setting information created by the information management unit 133. In step S337, the information management unit 133 transmits the client automatic setting information ID to the relay server 300.

After step S337, in step S338, the registration setting unit 335 of the relay server 300 stores the information obtained by the series of processes described above in the database of the storage unit 310 and the like for use in controlling whether to permit printing by the registered printer. More specifically, the registration setting unit 335 stores the virtual printer ID, the user ID, the printer email address, and the access key in the database. At this time, the registration setting unit 335 stores, in the database, the user ID acquired in step S313 as the user ID of the general user who performs the operation for printer registration (hereinafter also referred to as the registered user ID). Thus, the storage unit 310 stores the identification information on the user who issues a personal printer registration instruction. When no access key is set in the printer, storage of the access key is omitted in this step.

In step S339, the registration setting unit 335 of the relay server 300 sets a schedule for deleting the client automatic setting information stored in the first printing service system 100. For example, the schedule may be set such that the client automatic setting information is deleted after a certain period of time elapses. The certain period of time at this time can be freely set. For example, the certain period of time described above may be set according to an amount of the client automatic setting information stored in the first printing service system 100. For example, when the amount of the client automatic setting information stored in the first printing service system 100 is large, the certain period of time may be set to be short. Conversely, when the amount of the client automatic setting information stored in the first printing service system 100 is small, the certain period of time may be set to be long. When setting and storing the schedule described above, the registration setting unit 335 stores the schedule described above in association with the client automatic setting information ID. The client automatic setting information ID is used to specify the client automatic setting information to be deleted when deleting the client automatic setting information stored in the first printing service system 100.

Thereafter, in step S340, the Web browser 451 inquires the relay server 300 whether the printer registration process is completed. In response to this, in step S341, the registration setting unit 335 of the relay server 300 transmits a registration completion page, which is a page indicating that the registration is completed, to the Web browser 451. Accordingly, in step S342, the Web browser 451 displays the registration completion page on the display unit 420 of the terminal device 400.

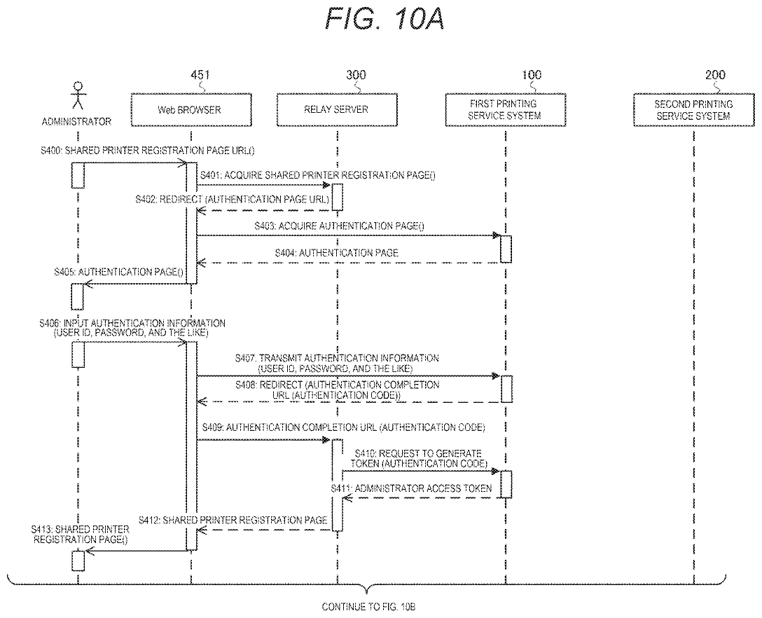

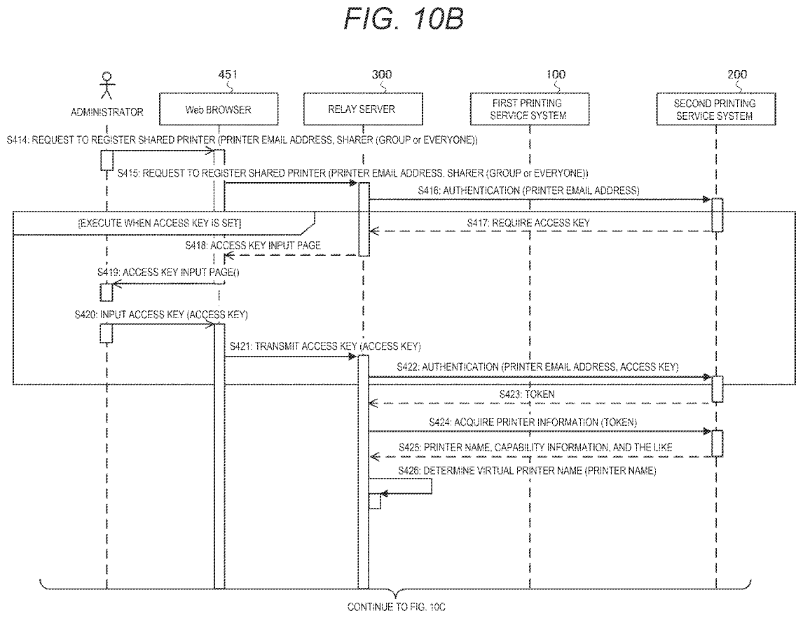

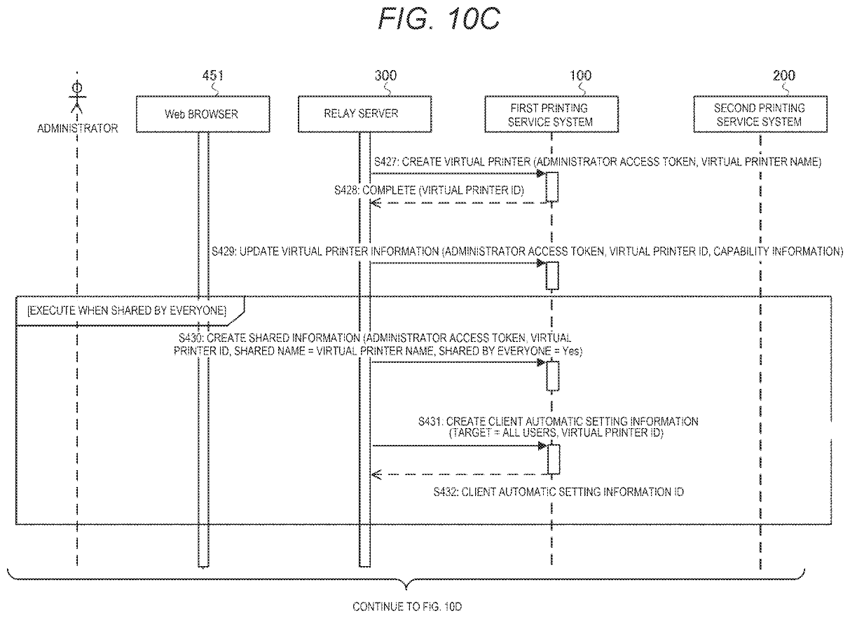

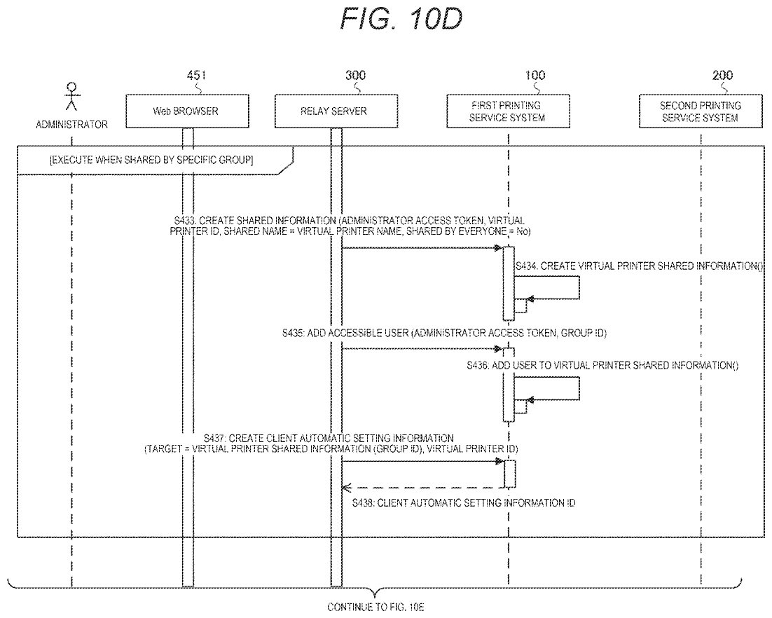

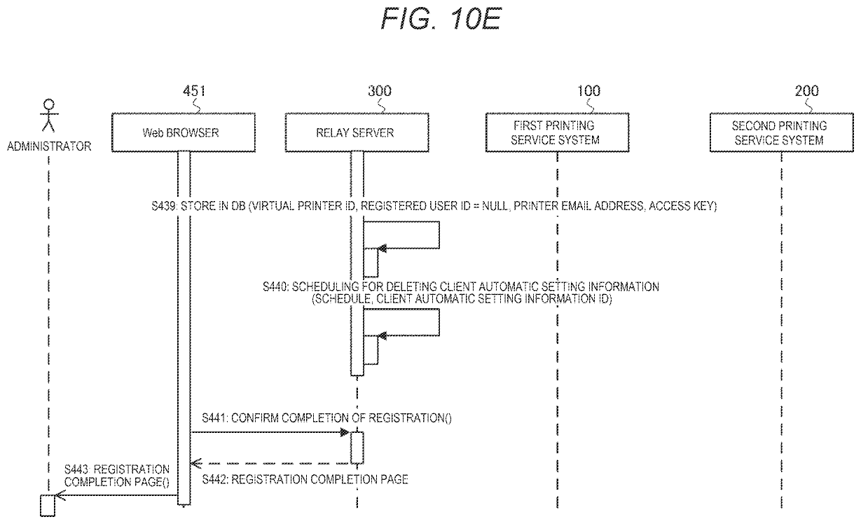

Next, a flow of a process for registering a shared printer in the first printing service system 100 will be described. FIGS. 10A to 10E are sequence charts showing an example of a flow of a shared printer registration process executed in the printing system 10. The shared printer is a printer that is assumed to be used by a plurality of users. That is, the shared printer is a printer shared by a plurality of users. An order of processes of steps in the sequence chart is merely an example, and can be appropriately changed as long as there is no technical contradiction. The flow of the shared printer registration process is described below with reference to FIGS. 10A to 10E.

In step S400, the administrator performs a predetermined operation for starting the shared printer registration process via the input unit 430 of the terminal device 400. Accordingly, for example, a URL of the shared printer registration page is input to the Web browser 451 of the terminal device 400. Here, the shared printer registration page is a page prepared to register a shared printer in the first printing service system 100. After step S400, in step S401, the Web browser 451 transmits, to the relay server 300, a request to acquire a shared printer registration page according to the input URL. In response to this, in step S402, the registration reception unit 333 of the relay server 300 instructs the Web browser 451 to access a predetermined redirect page. In this step, the predetermined redirect page is an authentication page. Therefore, the registration reception unit 333 of the relay server 300 transmits a URL of the authentication page to the Web browser 451.

In step S403, the Web browser 451 transmits, according to the received URL, a request to acquire the authentication page to the first printing service system 100. In response to this, in step S404, the authentication control unit 131 of the first printing service system 100 transmits the authentication page to the Web browser 451. Accordingly, in step S405, the Web browser 451 displays the authentication page on the display unit 420 of the terminal device 400.

In step S406, the administrator inputs authentication information to the authentication page via the input unit 430. Specifically, the administrator inputs a user ID, a password, and the like of the administrator. Here, the required authentication information is authentication information used in the first printing service system 100, and specifically, is a user ID, a password, and the like registered in advance. In step S407, the Web browser 451 transmits the input authentication information to the first printing service system 100. The authentication control unit 131 of the first printing service system 100 performs an authentication process based on the authentication information received from the Web browser 451. That is, the authentication control unit 131 determines whether the received authentication information matches authentication information on the administrator that is registered in advance.

When the authentication is successful in the authentication process, that is, when the received authentication information matches the authentication information on the administrator registered in advance, in step S408, the authentication control unit 131 of the first printing service system 100 issues an authentication code, and further, instructs the Web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the Web browser 451, together with the authentication code.

In step S409, the Web browser 451 accesses the predetermined redirect destination together with the authentication code. Accordingly, the relay server 300 acquires the authentication code. In step S410, the authentication control unit 331 of the relay server 300 transmits, to the first printing service system 100, a request requesting generation of an administrator token, together with the received authentication code. In step S411, after confirming that the authentication code received in step S410 matches the authentication code transmitted in step S408, the authentication control unit 131 of the first printing service system 100 issues an administrator access token, and transmits the administrator access token to the relay server 300. Thereafter, in step S412, the registration reception unit 333 transmits a shared printer registration page to the Web browser 451. Accordingly, in step S413, the Web browser 451 displays the shared printer registration page on the display unit 420 of the terminal device 400.

In step S414, the administrator performs, via the input unit 430 of the terminal device 400, a predetermined operation of requesting registration of the shared printer while designating the printer to be registered. In the embodiment, the printer to be registered is not a printer coupled to the first printing service system 100, but a printer coupled to the second printing service system 200, that is, the image forming device 500. This printer is registered in the first printing service system 100 by being associated with a virtual printer registered in the first printing service system 100. In step S414, more specifically, the administrator inputs, to the shared printer registration page displayed in step S413, identification information that identifies the printer to be registered and information that designates a sharer. For example, the administrator inputs information that designates a sharer and identification information on a printer disposed in a place where the designated sharer can use. The information that designates the sharer may be information that designates a user belonging to a specific group as the sharer. In this case, the information that designates the sharer may be identification information for specifying a group, such as a group ID. Instead of the identification information that specifies the group, a user ID of each of a plurality of users designated as the sharers may be input. The information that designates the sharer may be information that specifies any user, that is, all users, as the sharer. In the embodiment, as an example, the administrator inputs the email address of the printer to be registered as the identification information on a printer. That is, the email address for the printer to be registered is input to the Web browser 451 of the terminal device 400. Any other information that can uniquely identify the printer to be registered may be used instead of the email address.

Next, in step S415, the Web browser 451 transmits, to the relay server 300, a request requesting registration of the printer in the first printing service system 100, together with the information that designates the sharer and the email address of the printer to be registered. Accordingly, the registration reception unit 333 acquires a registration instruction for the image forming device 500 from the administrator. In response to this, in step S416, the authentication control unit 331 of the relay server 300 transmits the email address of the printer to be registered to the second printing service system 200 and requests authentication. When there is a printer corresponding to the email address and an access key such as a password is set in advance for the printer, processes from step S417 to step S422 to be described later are performed, and it is determined that the authentication is successful only when the access key is input. Meanwhile, when there is a printer corresponding to the email address and no access key is set for the printer, it is determined that the authentication is successful without performing the processes from steps S417 to S422 to be described later. A case where an access key is set to the printer specified by the email address is to be described below.

In step S417, the authentication control unit 231 of the second printing service system 200 requests the relay server 300 to transmit an access key. In response to this, in step S418, the authentication control unit 331 of the relay server 300 transmits, to the Web browser 451, an input page for receiving an input of the access key. Accordingly, in step S419, the Web browser 451 displays an access key input page on the display unit 420 of the terminal device 400. Next, in step S420, the administrator inputs the access key to the input page via the input unit 430. In step S421, the Web browser 451 transmits the input access key to the relay server 300. In step S422, the authentication control unit 331 of the relay server 300 transmits the email address and the access key of the printer to be registered to the second printing service system 200, and requests authentication again. In response to this, the authentication control unit 231 of the second printing service system 200 performs authentication based on the information transmitted from the relay server 300.

When the authentication succeeds, in step S423, the authentication control unit 231 of the second printing service system 200 issues a token and transmits the token to the relay server 300. The token is an access token for accessing predetermined information managed by the second printing service system 200. In step S424, the information acquisition unit 334 of the relay server 300 that acquires the token transmitted from the second printing service system 200 transmits, to the second printing service system 200, a request to acquire printer information about the printer to be registered, together with the token acquired in step S423.

In response to this, in step S425, after confirming that the token received in step S424 is valid, the information management unit 233 of the second printing service system 200 transmits the printer information on the image forming device 500, which is the printer to be registered in the first printing service system 100, to the relay server 300. Specifically, the information management unit 233 transmits, to the relay server 300, a printer name and capability information on the printer managed by the second printing service system 200. In this way, the relay server 300 acquires the printer information. The information acquisition unit 334 of the relay server 300 may store the acquired printer information in the storage unit 310 as necessary.

Next, in step S426, the registration setting unit 335 of the relay server 300 determines a printer name of the virtual printer to be registered in the first printing service system 100. That is, in step S426, the registration setting unit 335 determines the printer name of the virtual printer in order to register, in the first printing service system 100, the virtual printer associated with the physical shared printer. In this step, specifically, the registration setting unit 335 determines the printer name of the virtual printer using the printer name acquired in step S425. For example, the registration setting unit 335 determines the printer name of the virtual printer so as to include the acquired printer name.

Next, in step S427, the registration setting unit 335 of the relay server 300 requests the first printing service system 100 to register the virtual printer using the administrator access token acquired in step S411. Specifically, in step S427, the registration setting unit 335 transmits, to the first printing service system 100, a request requesting creation and registration of a virtual printer to be associated with the printer to be registered, together with the administrator access token. At this time, the registration setting unit 335 transmits the virtual printer name determined in step S426 together with the request. That is, the registration setting unit 335 requests registration of the virtual printer and setting of the virtual printer name.

In response to this, in step S428, after confirming that the administrator access token received in step S427 is valid, the information management unit 133 of the first printing service system 100 registers a new virtual printer in the first printing service system 100. At this time, the information management unit 133 sets the virtual printer name received in step S427 as the printer name of the virtual printer to be newly registered. The information management unit 133 determines a virtual printer ID for the new virtual printer as identification information of the new virtual printer, and notifies the relay server 300 of completion of the registration of the virtual printer together with the virtual printer ID.

Thereafter, in steps S429 to S438, a setting process for the newly registered virtual printer is performed. Specifically, in step S429, the registration setting unit 335 of the relay server 300 transmits, to the first printing service system 100, a request to update capability information on the newly registered virtual printer, together with the administrator access token. At this time, the registration setting unit 335 transmits the virtual printer ID notified in step S428 and the capability information acquired in step S425 together with the request. In response to this, after confirming that the administrator access token received in step S429 is valid, the information management unit 133 of the first printing service system 100 updates the information on the virtual printer specified by the received virtual printer ID. Specifically, the information management unit 133 sets the received capability information as the capability information on the virtual printer specified by the received virtual printer ID. Accordingly, the created capability information on the virtual printer is updated. In this sequence chart, a request to set the capability information is transmitted in step S429, but a request to set the virtual printer name may be transmitted. That is, the virtual printer name determined in step S426 may be set in a step different from a virtual printer registration step. In this case, in step S427, the first printing service system 100 may not be notified of the virtual printer name, or may be notified of a default virtual printer name.

In steps S430 to S438, the registration setting unit 335 of the relay server 300 performs setting related to shared use of the newly registered virtual printer. That is, in steps S430 to S438, an access right to the printer is set. Here, the following specific processes are performed in order to perform the setting for using the printer to be registered as the shared printer. When the shared printer is to be shared by any user, that is, when the relay server 300 receives information that designates any user as a sharer in step S415, the registration setting unit 335 executes processes of steps S430 to S432 to be described below. When the shared printer is to be shared by a user belonging to a specific group, that is, when the relay server 300 receives information that designates a user belonging to a specific group as a sharer in step S415, the registration setting unit 335 executes processes of steps S433 to S438 to be described below.

First, a case where the shared printer is shared by everyone will be described. When the relay server 300 receives information that designates any user as a sharer, the registration setting unit 335 performs a process for creating shared information in step S430. As described above, since it is necessary to allow any user to use the printer to be registered, shared information that permits sharing by any user is created. More specifically, in step S430, the registration setting unit 335 transmits, to the first printing service system 100, a request to set the shared information on the newly registered virtual printer, together with the administrator access token. At this time, together with the request, the registration setting unit 335 also transmits the virtual printer ID notified in step S428 and an instruction designating that sharing by any user is permitted. At this time, the registration setting unit 335 may transmit a shared name for identifying newly created shared information to the first printing service system 100. For example, the virtual printer name determined in step S426 may be used as such a shared name. The transmission of the shared name may be omitted. In response to this, after confirming that the administrator access token received in step S430 is valid, the information management unit 133 of the first printing service system 100 creates, based on the received information, shared information on the virtual printer specified by the virtual printer ID. Specifically, the information management unit 133 creates shared information indicating that the sharing by any user is permitted.

In step S431, the registration setting unit 335 of the relay server 300 requests the first printing service system 100 to create client automatic setting information. Specifically, the registration setting unit 335 transmits, to the first printing service system 100, a request requesting generation of the client automatic setting information, together with the shared information on the virtual printer and the virtual printer ID notified in step S428. When the shared printer is shared by any user, that is, when the shared printer is shared by everyone, the virtual printer shared information is all users.

The information management unit 133 of the first printing service system 100 creates the client automatic setting information and stores the client automatic setting information in the storage unit 110. The client automatic setting information created at this time includes the virtual printer name, the virtual printer ID, the capability information, and the virtual printer shared information. The virtual printer shared information corresponds to access right information that defines a user who can access the image forming device 500, and when the shared printer is shared by everyone, all users are targets.

The information management unit 133 of the first printing service system 100 generates a client automatic setting information ID that is identification information for specifying the client automatic setting information created by the information management unit 133. In step S432, the information management unit 133 transmits the client automatic setting information ID to the relay server 300.

Next, a case where the shared printer is shared by a specific group will be described. When the relay server 300 receives the information that designates a user belonging to a specific group as a sharer, the registration setting unit 335 first performs a process for creating shared information in step S433. Since it is necessary to prevent a user other than the user belonging to the specific group from using the printer to be registered, shared information not permitting sharing by any user is created. More specifically, in step S433, the registration setting unit 335 transmits, to the first printing service system 100, a request to set the shared information on the newly registered virtual printer, together with the administrator access token. At this time, together with the request, the registration setting unit 335 also transmits the virtual printer ID notified in step S428 and an instruction designating that sharing by any user is not permitted. At this time, the registration setting unit 335 may transmit a shared name for identifying newly created shared information to the first printing service system 100. For example, the virtual printer name determined in step S426 may be used as such a shared name. The transmission of the shared name may be omitted. In response to this, in step S434, after confirming that the administrator access token received in step S433 is valid, the information management unit 133 of the first printing service system 100 creates, based on the received information, shared information on the virtual printer specified by the virtual printer ID. Specifically, the information management unit 133 creates shared information indicating that sharing by any user is not permitted.

In step S435, the registration setting unit 335 performs a process of correcting the shared information such that only the user belonging to the specific group can use the printer to be registered. Specifically, in step S435, the registration setting unit 335 transmits, to the first printing service system 100, a request to correct the shared information so as to permit the user belonging to the specific group to use the virtual printer, together with the administrator access token. At this time, the registration setting unit 335 transmits, for example, the group ID acquired in step S415 as information for specifying a user to whom sharing is permitted. In response to this, in step S436, after confirming that the administrator access token received in step S435 is valid, the information management unit 133 of the first printing service system 100 updates the shared information based on the received information. Specifically, the information management unit 133 updates the shared information so as to permit the use of the user specified by the received group ID.

After step S436, in step S437, the registration setting unit 335 of the relay server 300 requests the first printing service system 100 to create client automatic setting information. Specifically, the registration setting unit 335 transmits, to the first printing service system 100, a request requesting generation of the client automatic setting information, together with the shared information on the virtual printer and the virtual printer ID notified in step S428. Here, the shared information on the virtual printer corresponds to virtual printer shared information created in step S435, and corresponds to the group ID in this case.

The information management unit 133 of the first printing service system 100 creates the client automatic setting information and stores the client automatic setting information in the storage unit 110. The client automatic setting information created at this time includes the virtual printer name, the virtual printer ID, the capability information, and the virtual printer shared information. The virtual printer shared information corresponds to access right information that defines a user who can access the image forming device 500. When the shared printer is shared by a specific group, the virtual printer shared information can be a group ID of a group for which use of the shared printer is permitted.

The information management unit 133 of the first printing service system 100 generates a client automatic setting information ID that is identification information for specifying the client automatic setting information created by the information management unit 133. In step S438, the information management unit 133 transmits the client automatic setting information ID to the relay server 300.

After step S432 or step S438, in step S439, the registration setting unit 335 of the relay server 300 stores the information obtained by the series of processes described above in the database of the storage unit 310 and the like for use in controlling whether to permit printing by the registered printer. More specifically, the registration setting unit 335 stores the virtual printer ID, the printer email address, and the access key in the database. When no access key is set in the printer, storage of the access key is omitted in this step. In this sequence chart, since the registration of the shared printer is performed by an operation of an administrator, which is not the registration of a personal printer performed by an operation of a general user, the registration setting unit 335 does not store a user ID of a specific user as the registered user ID. Instead, the registration setting unit 335 stores a predetermined value (for example, NULL value), which is not the user ID of a specific user, in the database as the registered user ID.

In step S440, the registration setting unit 335 of the relay server 300 sets a schedule for deleting the client automatic setting information stored in the first printing service system 100. For example, the schedule may be set such that the client automatic setting information is deleted after a certain period of time elapses. The certain period of time at this time can be freely set. For example, the certain period of time described above may be set according to an amount of the client automatic setting information stored in the first printing service system 100. For example, when the amount of the client automatic setting information stored in the first printing service system 100 is large, the certain period of time may be set to be short. Conversely, when the amount of the client automatic setting information stored in the first printing service system 100 is small, the certain period of time may be set to be long. When setting and storing the schedule described above, the registration setting unit 335 stores the schedule described above in association with the client automatic setting information ID. The client automatic setting information ID is used to specify the client automatic setting information to be deleted when deleting the client automatic setting information stored in the first printing service system 100.

In step S441, the Web browser 451 inquires the relay server 300 whether the printer registration process is completed. In response to this, in step S442, the registration setting unit 335 of the relay server 300 transmits a registration completion page, which is a page indicating that the registration is completed, to the Web browser 451. Accordingly, in step S443, the Web browser 451 displays the registration completion page on the display unit 420 of the terminal device 400.

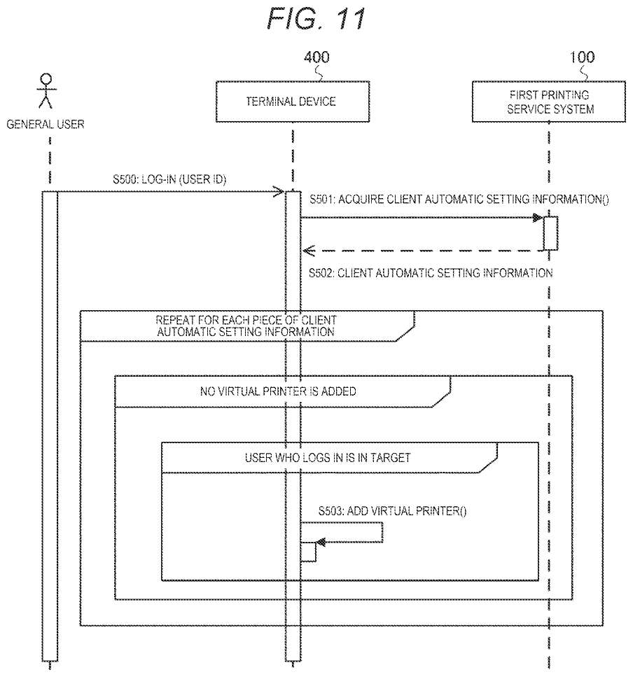

Next, a flow of a process of registering a printer in the terminal device 400 will be described. FIG. 11 is a sequence chart showing an example of the flow of the process of registering a printer in the terminal device 400.

In step S500, the general user logs in the terminal device 400 when performing a predetermined task using the terminal device 400. Specifically, the general user inputs a user ID, a password, and the like of the general user via the input unit 430 of the terminal device 400, and logs in the terminal device 400.

Thereafter, in step S501, the terminal device 400 requests the first printing service system 100 to transmit the client automatic setting information to the terminal device 400. Here, after the general user logs in the terminal device 400, the terminal device 400 automatically requests the first printing service system 100 to transmit the client automatic setting information.

In step S502, the information management unit 133 of the first printing service system 100 transmits the client automatic setting information to the terminal device 400 in response to the request from the terminal device 400. The client automatic setting information transmitted at this time is a list including the client automatic setting information created in step S336 in FIG. 9D and the client automatic setting information created in step S431 in FIG. 10C and step S437 in FIG. 10D. The client automatic setting information includes access right information that defines a user who can access the image forming device 500 and identification information for specifying the image forming device 500. The identification information for specifying the image forming device 500 is a virtual printer ID.

Upon acquiring the client automatic setting information from the first printing service system 100, the printer setting unit 454 of the terminal device 400 registers the image forming device 500 in the terminal device 400 using the acquired client automatic setting information. Specifically, when access right information in the client automatic setting information includes the user who logs in the terminal device 400, and a virtual printer corresponding to the client automatic setting information, which corresponds to the image forming device 500, is not registered in the terminal device 400, the printer setting unit 454 adds the virtual printer to the terminal device 400 in step S503. The printer setting unit 454 repeats the above operation for each piece of client automatic setting information acquired from the first printing service system 100.

Through such a process, the printer setting unit 454 can automatically add, to the terminal device 400, a virtual printer in which access right information in the client automatic setting information includes the user who logs in the terminal device 400. For example, the printer setting unit 454 creates a print queue for the virtual printer registered in the first printing service system 100 in the terminal device 400. Determination on whether the access right information in the client automatic setting information includes the user who logs in the terminal device 400 can be performed by comparing a user ID used when the user logs in the terminal device 400 with a user ID or a group ID in the access right information in the client automatic setting information.

In the embodiment, in step S501, when the terminal device 400 requests the first printing service system 100 to transmit the client automatic setting information, the user ID may be transmitted. In this case, the information management unit 133 of the first printing service system 100 extracts, from the client automatic setting information stored in the storage unit 110, the client automatic setting information in which the access right information in the client automatic setting information includes the user ID acquired from the terminal device 400. In step S502, the information management unit 133 may transmit the extracted client automatic setting information to the terminal device 400.

When a virtual printer corresponding to the client automatic setting information acquired from the first printing service system 100, which corresponds to the image forming device 500, is not registered in the terminal device 400, the printer setting unit 454 of the terminal device 400 may add the virtual printer to the terminal device 400 in step S503. That is, in this case, a first printing service system 100 side determines whether the access right information in the client automatic setting information includes the user who logs in the terminal device 400.

Thus, in the embodiment, since the printer setting unit 454 automatically registers the image forming device 500, it is easy to register the image forming device 500 in the terminal device 400. That is, the user does not need to manually perform setting when registering the image forming device 500 in the terminal device 400, and thus it is possible to prevent the registration of the image forming device 500 from becoming complicated.

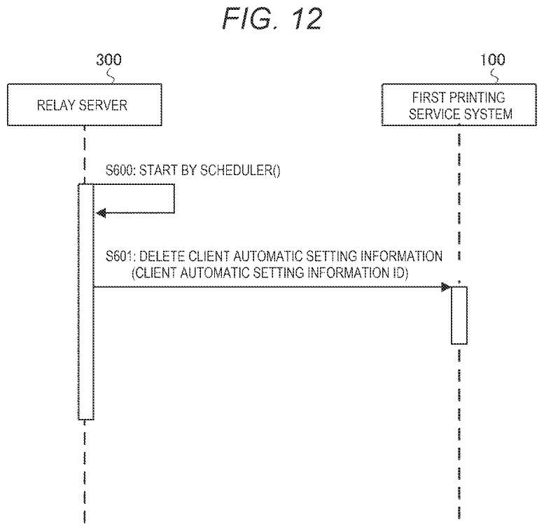

Next, a flow of a process of deleting the client automatic setting information from the first printing service system will be described. FIG. 12 is a sequence chart showing an example of the flow of the process of deleting the client automatic setting information from the first printing service system.

In the relay server 300, a schedule for deleting the client automatic setting information stored in the first printing service system 100 is set in advance. That is, when a general user registers the image forming device 500 in the first printing service system 100, the registration setting unit 335 of the relay server 300 sets a schedule for deleting the client automatic setting information stored in the first printing service system 100 in step S339 in FIG. 9D. Similarly, when the administrator registers the image forming device 500 in the first printing service system 100, the registration setting unit 335 of the relay server 300 sets a schedule for deleting the client automatic setting information stored in the first printing service system 100 in step S440 in FIG. 10E. At this time, the registration setting unit 335 of the relay server 300 sets and stores the schedule, and stores the schedule in association with the client automatic setting information ID. The client automatic setting information ID is used to specify the client automatic setting information to be deleted when deleting the client automatic setting information stored in the first printing service system 100.

In step S600, when a scheduler is started based on the schedule set as described above, the registration setting unit 335 of the relay server 300 transmits, to the first printing service system 100, an instruction to delete the client automatic setting information stored in the first printing service system 100, together with the client automatic setting information ID in step S601. Accordingly, the first printing service system 100 deletes, from the client automatic setting information stored in the first printing service system 100, the client automatic setting information specified by the client automatic setting information ID.

In the embodiment, the client automatic setting information stored in the first printing service system 100 is deleted based on the predetermined schedule. Therefore, it is possible to suppress an increase in the load of the first printing service system 100 and to suppress a decrease in the performance of the first printing service system 100.

That is, since the first printing service system 100 is a cloud system, when the number of users of the first printing service system 100 increases, the amount of the client automatic setting information also increases accordingly. Thus, when the amount of the client automatic setting information increases, the load of the first printing service system 100 increases, and the performance of the first printing service system 100 may decrease. In the embodiment, by deleting the client automatic setting information stored in the first printing service system 100 based on the predetermined schedule, it is possible to suppress an increase in the load of the first printing service system 100 and to suppress a decrease in the performance of the first printing service system 100.

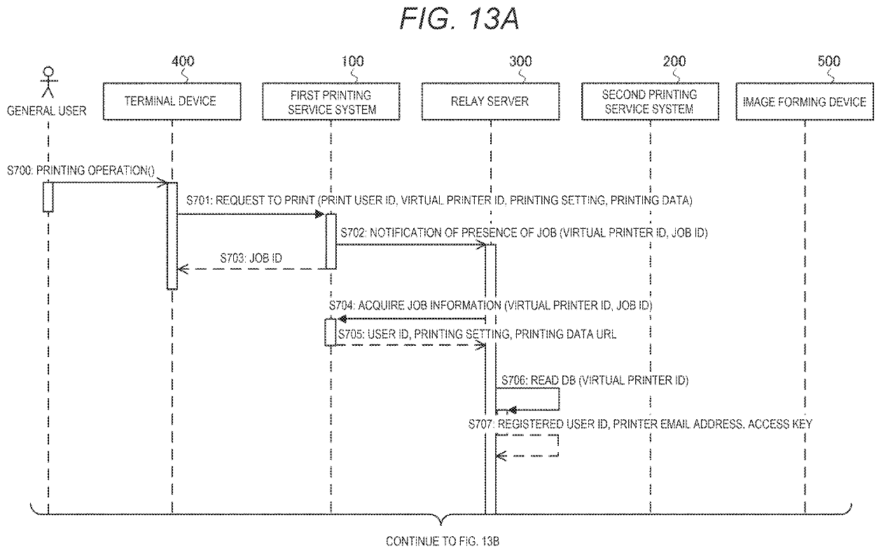

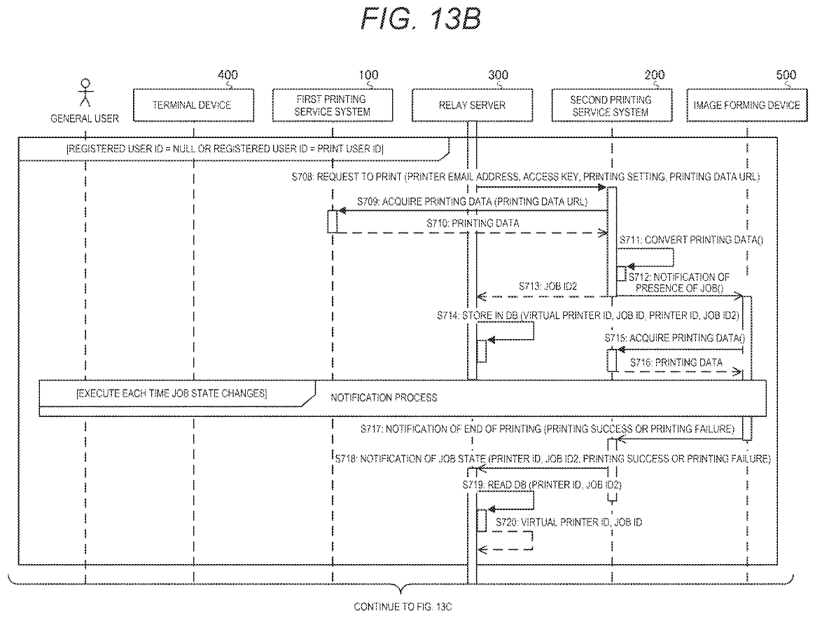

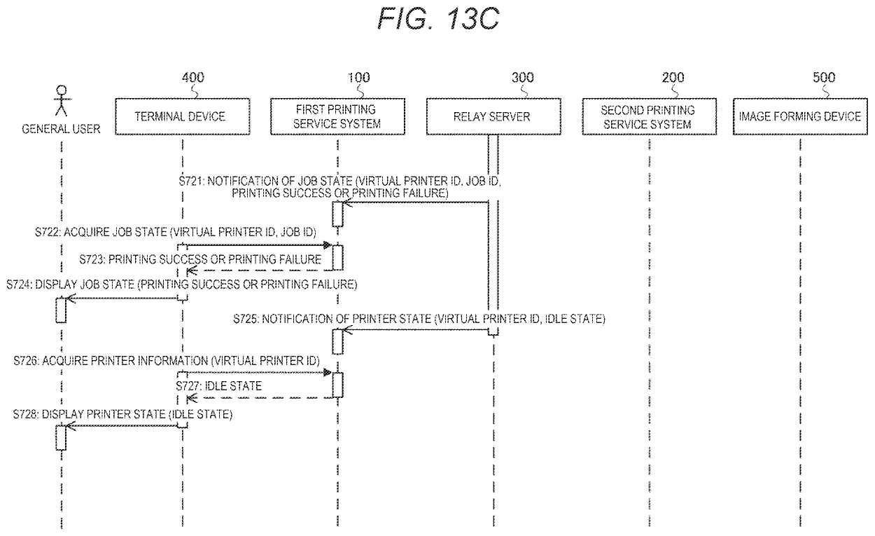

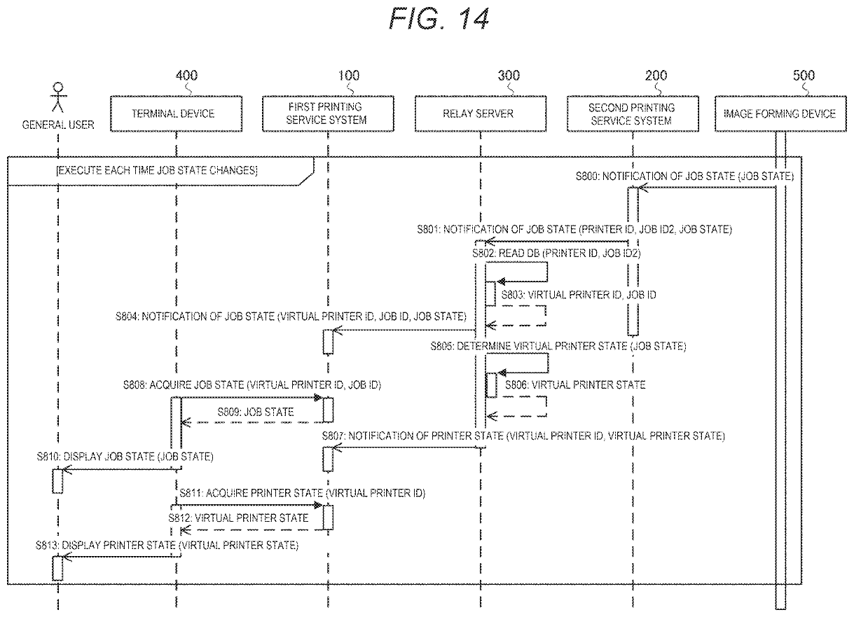

Next, a flow of a printing process when the image forming device 500, which is a printer coupled to the second printing service system 200, performs printing via the first printing service system 100 will be described. FIGS. 13A to 13C and FIG. 14 are sequence charts showing an example of the flow of the printing process executed in the printing system 10. In particular, these sequence charts show the flow of the printing process when a user designates printing by a printer coupled to the second printing service system 200 and already registered in the first printing service system 100 by a registration process shown in FIG. 9A to 9D or 10A to 10E. An order of processes of steps in the sequence chart is merely an example, and can be appropriately changed as long as there is no technical contradiction. Hereinafter, the flow of the printing process will be described with reference to FIGS. 13A to 13C and FIG. 14.

In step S700, the general user performs a predetermined operation for printing data to be printed via the input unit 430 of the terminal device 400. Hereinafter, data to be printed is referred to as printing data. Specifically, the general user performs an operation of designating a printer used for printing, printing data, and printing setting. Here, as described above, the image forming device 500 that is a printer coupled to the second printing service system 200 is designated as a printer used for printing. More specifically, a virtual printer corresponding to the image forming device 500 is designated. In the embodiment, a user interface screen is configured such that the virtual printer registered in the terminal device 400 by the process in FIG. 11, that is, only the printer to which the user has an access right, is displayed as an option of the printer used for printing.

The printing setting designated in step S700 is a setting value set in the printer for printing. Examples of the printing setting include, but are not limited to, a setting value for designating a size of a sheet to be used, a setting value for designating whether to perform color printing, and a setting value for designating whether to perform double-sided printing.

When the operation in step S700 is performed, in step S701, the printing request unit 452 of the terminal device 400 requests the first printing service system 100 to perform printing. At this time, the printing request unit 452 transmits a user ID of the user who instructs printing in step S700, a virtual printer ID of the designated printer, the designated printing setting, and the designated printing data to the first printing service system 100. Then, the first printing service system 100 acquires these pieces of information.

Next, in step S702, the printing control unit 132 of the first printing service system 100 generates a printing job based on the information received in step S701, and notifies the relay server 300 of presence of the printing job. Specifically, the printing control unit 132 notifies the relay server 300 of a job ID, which is identification information on the printing job, and the virtual printer ID of the designated printer. In step S703, the printing control unit 132 notifies the terminal device 400 of the job ID.

When the relay server 300 receives the notification in step S702, in step S704, the printing control unit 332 of the relay server 300 transmits a request to acquire job information to the first printing service system 100. Specifically, the printing control unit 332 transmits the request together with the virtual printer ID and the job ID notified in step S704. In response to this, in step S705, the printing control unit 132 of the first printing service system 100 transmits, to the relay server 300, the user ID and the printing setting received in step S701 and a URL indicating a storage location of the printing data received in step S701 as job information. In the following description, the URL indicating the storage location of the printing data is referred to as a printing data URL.

When the relay server 300 receives the job information, in step S706, the printing control unit 332 of the relay server 300 performs a process of reading the database of the storage unit 310 and the like in order to acquire information stored in association with the received virtual printer ID. Accordingly, in step S707, the printing control unit 332 reads a registered user ID, a printer email address, and an access key stored in association with the virtual printer ID. These pieces of information is the information stored in step S338 or step S439 described above.

After step S707, the printing control unit 332 of the relay server 300 performs a determination process for preventing the personal printer from being used by an inappropriate user. Specifically, the printing control unit 332 determines whether a user other than the general user who performs the operation for registering the personal printer is performing the operation for printing using the personal printer. Unless the use of the personal printer by an inappropriate user is requested, that is, unless a user other than the general user who performs the operation for registering the personal printer performs the operation for printing using the personal printer, processes from step S708 to step S720 are performed. Meanwhile, when use of the personal printer by an inappropriate user is requested, that is, when a user other than the general user who performs the operation for registering the personal printer performs the operation for printing using the personal printer, printing is not performed, and in step S721 to be described later, the printing control unit 332 outputs an error to the first printing service system 100.

The printing control unit 332 performs the following determination process in more detail as a determination process for preventing the personal printer from being used by an inappropriate user. When the designated printer is registered in the first printing service system 100 as a personal printer, if the user who registers the designated printer in the first printing service system 100 matches the user who instructs printing, the printing control unit 332 determines that use of the personal printer by an inappropriate user is not requested. Specifically, when a value of the registered user ID read in step S707 is not a NULL value, if the user ID received in step S705 matches the registered user ID read in step S707, the printing control unit 332 determines that the personal printer is not used by an inappropriate user. In this case, the printing control unit 332 transmits the printing request to the second printing service system 200 in step S708 to be described later.

Meanwhile, when the designated printer is registered in the first printing service system 100 as a personal printer, if the user who registers the printer in the first printing service system 100 is different from the user who instructs printing, the printing control unit 332 determines that use of the personal printer by an inappropriate user is requested. Specifically, when the value of the registered user ID read in step S707 is not a NULL value, if the user ID received in step S705 does not match the registered user ID read in step S707, the printing control unit 332 determines that the personal printer is used by an inappropriate user. Therefore, at this time, printing is not performed and an error is output. In this case, the printing control unit 332 does not transmit the printing request to the second printing service system 200.

Thus, when a personal printer is designated as a printer used in printing according to a printing job, the printing control unit 332 transmits a printing request requesting printing by the personal printer only when the printing job is a printing job corresponding to a printing instruction from the user who registers the personal printer. At this time, more specifically, the printing control unit 332 determines whether to transmit the printing request by comparing the registered user ID that is the identification information stored for the registered user with the user ID that is identification information on the user who issues the printing instruction corresponding to the printing job. According to this configuration, it is possible to prevent a user other than a certain user from using a personal printer registered by the certain user.

As described above, in the embodiment, the access right is set so that the general user who can access the personal printer is limited to only the user who registers the personal printer. However, even if such setting is made, a user having higher authority than the user, such as an administrator, may be able to use the personal printer. The access right of the personal printer, which is the attribute information managed by the first printing service system 100, is information that can be freely set by the administrator. Therefore, the administrator may erroneously make setting to give the access right of the personal printer to another user. That is, in this case, the personal printer may be used by other users. In contrast, in the embodiment, as described above, the relay server 300 compares the registered user with the user who instructs printing, and determines whether the personal printer can be used. Therefore, in such a case as described above, it is possible to appropriately prevent the personal printer from being used by other users.

When a designated printer is registered as the shared printer in the first printing service system 100, the printing control unit 332 determines that the use of a personal printer by an inappropriate user is not requested regardless of the user who instructs printing. Specifically, when the value of the registered user ID read in step S707 is a NULL value, the printing control unit 332 determines that the personal printer is not used by an inappropriate user regardless of the user who instructs printing. In this case, the printing control unit 332 transmits the printing request to the second printing service system 200 in step S708 to be described later.

Thus, when a shared printer is designated as a printer used in printing according to a printing job, the printing control unit 332 transmits a printing request requesting printing by the shared printer to the second printing service system 200 regardless of whether the printing job corresponds to a printing instruction by any user. Therefore, a user who does not register a personal printer can also use the printing service using the system.

In step S708, the printing control unit 332 of the relay server 300 requests the second printing service system 200 to perform printing. At this time, the printing control unit 332 transmits, to the second printing service system 200, the printer email address and the access key read in step S707 and the printing setting and the printing data URL acquired in step S705. Thus, the printing control unit 332 has a function of transmitting a printing request to the second printing service system 200 in response to a printing job from the first printing service system 100.

When the second printing service system 200 receives the printing request from the relay server 300, in step S709, the printing control unit 232 of the second printing service system 200 accesses the printing data URL notified in step S708 in order to acquire the printing data. Accordingly, in step S710, the printing control unit 232 of the second printing service system 200 acquires the printing data from the first printing service system 100.

After step S710, in step S711, the printing control unit 232 converts the printing data acquired in step S710 into printing data conforming to a predetermined printer language. Thereafter, in step S712, the printing control unit 232 notifies the image forming device 500, which is a printer used for printing, of presence of a printing job for printing the converted printing data. The printing job is a printing job corresponding to the printing job managed by the first printing service system 100, and is a printing job managed by the printing control unit 232 of the second printing service system 200. Therefore, a new ID is assigned in addition to the job ID value described above. Hereinafter, an ID of the printing job managed by the printing control unit 232 of the second printing service system 200 is referred to as a job ID2. In step S713, the printing control unit 232 of the second printing service system 200 notifies the relay server 300 of the job ID2. In response to this, in step S714, the printing control unit 332 of the relay server 300 performs a process of storing a correspondence relationship between a printing job in the first printing service system 100 and a printing job in the second printing service system 200. Specifically, the printing control unit 332 stores the virtual printer ID, the job ID of the first printing service system 100, the printer ID of the printer used for printing, and the job ID of the second printing service system 200, that is, the job ID2, in association with one another in the database of the storage unit 310 and the like.

When the image forming device 500 receives the notification in step S712, in step S715, the printing processing unit 541 of the image forming device 500 transmits a request to acquire printing data to the second printing service system 200. In response to this, in step S716, the printing control unit 232 of the second printing service system 200 transmits the converted printing data to the image forming device 500.

After step S716, every time the job state changes, a notification process shown in the sequence chart in FIG. 14 is executed. Thereafter, a process in step S717 is performed. Here, a flow of a process executed every time the job state changes will be described with reference to FIG. 14. For example, the process shown in FIG. 14 is executed when a printing process is started in the image forming device 500 or when an error occurs after start of the printing process. An order of processes of steps in the sequence chart is merely an example, and can be appropriately changed as long as there is no technical contradiction.

In step S800, the printing processing unit 541 of the image forming device 500 notifies the second printing service system 200 of the job state. When the second printing service system 200 receives this notification, in step S801, the printing control unit 232 of the second printing service system 200 notifies the relay server 300 of the job state notified in step S800 together with the printer ID and the job ID2. Accordingly, the printing control unit 332 of the relay server 300 acquires the job state regarding the printing process executed by the image forming device 500.

When the relay server 300 receives the notification of the job state, in step S802, the printing control unit 332 of the relay server 300 performs a process of reading the database of the storage unit 310 and the like to acquire information stored in association with the received printer ID and job ID2. Accordingly, in step S803, the printing control unit 332 reads the virtual printer ID and the job ID stored in association with the printer ID and the job ID2. In step S804, the printing control unit 332 of the relay server 300 notifies the first printing service system 100 of the job state notified in step S801 together with the virtual printer ID and the job ID. That is, when acquiring the job state from the second printing service system 200, the printing control unit 332 transmits the job state to the first printing service system 100.

In the embodiment, the first printing service system 100 manages not only the job state but also the printer state. Meanwhile, the second printing service system 200 manages the job state but does not manage the printer state. Here, the job state refers to a state of a process for each printing job, in other words, a state of a process for each printing process, and the printer state refers to a state of a printer that affects all printing jobs processed by one printer, in other words, affects all printing processes processed by one printer.

In the embodiment, in order to notify the first printing service system 100 of the printer state, in step S805, the printing control unit 332 of the relay server 300 performs a process of determining the printer state using the job state notified from the second printing service system 200. That is, the printing control unit 332 determines a state of the image forming device 500 based on the job state acquired from the second printing service system 200. Accordingly, in step S806, a printer state of a virtual printer is determined. Specifically, when the job state notified from the second printing service system 200 indicates an error that does not depend on the printing job, the printing control unit 332 also uses the job state as the printer state. For example, when the job state notified from the second printing service system 200 indicates a printing error due to shortage of a printing medium, the printing control unit 332 determines that printer states of the image forming device 500 and the virtual printer associated with the image forming device 500 is a printing medium shortage state. The printing medium is, for example, a paper sheet, but may be a medium made of a material other than paper. For example, when the job state notified from the second printing service system 200 indicates a printing error due to shortage of a color material, the printing control unit 332 determines that the printer states of the image forming device 500 and the virtual printer associated with the image forming device 500 is a color material shortage state. The color material is, for example, ink, but may be toner. When the job state notified from the second printing service system 200 is a state in which printing is normally performed, the printing control unit 332 may use the job state as the printer state. That is, the printing control unit 332 may determine that the printer state is a printing state.

In step S807, the printing control unit 332 of the relay server 300 notifies the first printing service system 100 of the printer state of the virtual printer determined in step S806 together with the virtual printer ID. That is, the printing control unit 332 transmits a state of the image forming device 500 to the first printing service system 100. Therefore, when the job state notified from the second printing service system 200 in step S801 indicates a printing error due to, for example, shortage of paper sheet or shortage of ink, the printing error due to the shortage of paper sheet or the shortage of ink is notified as the job state to the first printing service system 100, and a state of the shortage of paper sheet or the shortage of ink is notified as the printer state.

Meanwhile, when the job state notified from the second printing service system 200 indicates an error specific to the printing job, the printing control unit 332 does not reflect the job state in the printer state. For example, when the job state notified from the second printing service system 200 indicates a printing error due to a communication error, the printing control unit 332 does not reflect the job state in the printer states of the image forming device 500 and the virtual printer associated with the image forming device 500. For example, when the job state notified from the second printing service system 200 indicates cancellation of the printing job based on an instruction or the like from the user, the printing control unit 332 does not reflect the job state in the printer states of the image forming device 500 and the virtual printer associated with the image forming device 500. Therefore, when the job state notified from the second printing service system 200 in step S801 indicates, for example, a communication error or cancellation of the printing job, the communication error or cancellation of the printing job is notified to the first printing service system 100 as the job state, and notification of the printer state is omitted.

In step S808, the state output unit 453 of the terminal device 400 transmits a request to acquire job information to the first printing service system 100 by designating the virtual printer ID and the job ID. In response to this, in step S809, the printing control unit 132 of the first printing service system 100 transmits the job state received in step S804 to the terminal device 400. Accordingly, in step S810, the state output unit 453 of the terminal device 400 displays the job state on the display unit 420 of the terminal device 400.

In step S811, the state output unit 453 of the terminal device 400 transmits, to the first printing service system 100, a request to acquire the printer state by designating the virtual printer ID. In response to this, in step S812, the printing control unit 132 of the first printing service system 100 transmits the printer state received in step S807 to the terminal device 400. Accordingly, in step S813, the state output unit 453 of the terminal device 400 displays the printer state on the display unit 420 of the terminal device 400.

As can be seen from this sequence chart, each time the job state is updated, the printing control unit 332 of the relay server 300 transmits an updated job state to the first printing service system 100. Therefore, the user can appropriately grasp a current job state via the first printing service system 100.

Returning to FIG. 13B, processes after step S717 will be described. In step S717, when the printing process ends, the printing processing unit 541 of the image forming device 500 notifies the second printing service system 200 of an end of the printing by notifying a processing result of the printing job. Specifically, the printing processing unit 541 notifies the second printing service system 200 whether the printing process is normally completed. That is, the printing processing unit 541 notifies the second printing service system 200 whether the printing is successful or failed. When the second printing service system 200 receives this notification, in step S718, the printing control unit 232 of the second printing service system 200 notifies the relay server 300 of the processing result notified in step S717 as the job state together with the printer ID and the job ID2. Accordingly, the printing control unit 332 of the relay server 300 acquires the job state regarding the printing process executed by the image forming device 500.

When the relay server 300 receives the notification of the job state, in step S719, the printing control unit 332 of the relay server 300 performs a process of reading the database of the storage unit 310 and the like to acquire information stored in association with the received printer ID and job ID2. Accordingly, in step S720, the printing control unit 332 reads the virtual printer ID and the job ID stored in association with the printer ID and the job ID2.

Next, in step S721, the printing control unit 332 of the relay server 300 notifies the first printing service system 100 of the job state together with the virtual printer ID and the job ID. That is, when acquiring the job state from the second printing service system 200, the printing control unit 332 transmits the job state to the first printing service system 100. As described above, when it is determined that use of the personal printer by the inappropriate user is requested, the process up to step S720 is skipped, and in this step, the job state indicating a printing failure due to use of the personal printer by the inappropriate user is notified to the first printing service system 100. More specifically, in this case, occurrence of an error due to the use of the personal printer by an inappropriate user is notified.

In step S722, the state output unit 453 of the terminal device 400 transmits a request to acquire job information to the first printing service system 100 by designating the virtual printer ID and the job ID. In response to this, in step S723, the printing control unit 132 of the first printing service system 100 transmits the job state received in step S721 to the terminal device 400. Accordingly, in step S724, the state output unit 453 of the terminal device 400 displays the job state on the display unit 420 of the terminal device 400.

When the relay server 300 receives the notification of the processing result of the printing job, in step S725, the printing control unit 332 of the relay server 300 determines that the image forming device 500 and the virtual printer are in an idle state (standby state), and notifies the first printing service system 100 of the printer state. More specifically, the printing control unit 332 determines that the printer states of the virtual printer and the associated image forming device 500 are an idle state when the printing process is normally completed for all printing jobs for the same virtual printer, that is, for the same image forming device 500. Thus, the printing control unit 332 determines a state of the image forming device 500 based on the job state acquired from the second printing service system 200. Specifically, in step S725, the printing control unit 332 notifies the first printing service system 100 that the printer state of the virtual printer is the idle state together with the virtual printer ID. Thus, the printing control unit 332 transmits a state of the image forming device 500 to the first printing service system 100.

Thereafter, in step S726, the state output unit 453 of the terminal device 400 transmits, to the first printing service system 100, a request to acquire a printer state by designating the virtual printer ID. In response to this, in step S727, the printing control unit 132 of the first printing service system 100 transmits to the terminal device 400 that the printer state is an idle state. Accordingly, in step S728, the state output unit 453 of the terminal device 400 displays that the printer state is the idle state on the display unit 420 of the terminal device 400.

The flow of the printing process when the printer coupled to the second printing service system 200 performs printing via the first printing service system 100 is described above using the sequence chart. As can be seen from this sequence chart, the printing control unit 332 of the relay server 300 relays, between the first printing service system 100 and the second printing service system 200, the information on the printing job for printing the printing data. The image forming device 500 prints the printing data based on the information on the printing job relayed by the relay server 300. Therefore, in a system in which the first printing service system 100 and the second printing service system 200 cooperate with each other, the image forming device 500 can execute printing.

As can be seen from the sequence chart, in the embodiment, the printing control unit 332 of the relay server 300 acquires the job state regarding the printing process performed by the image forming device 500 from the second printing service system 200, and transmits the job state to the first printing service system 100. Therefore, the first printing service system 100 can provide the user with information on the job state. As described above, the job state transmitted to the first printing service system 100 may be a job state indicating a state in which a printing error occurs after the execution of the printing process, or may be a job state indicating a state in which the printing process is normally completed. The printing control unit 332 of the relay server 300 determines the state of the image forming device 500 based on the job state acquired from the second printing service system 200, and transmits the state of the image forming device 500 to the first printing service system 100. Therefore, the first printing service system 100 can provide the user with information on the state of the image forming device 500. The first printing service system 100 is coupled to a terminal device 400 that acquires and outputs a job state and a state of the image forming device 500 via the first printing service system 100. Therefore, the user can easily grasp the states using the terminal device 400.

The present disclosure is not limited to the embodiment described above, and can be appropriately modified without departing from the scope of the present disclosure. For example, the relay server 300 may be provided in the second printing service system 200. According to this configuration, for example, the same vendor can easily manage the relay server 300 and the second printing service system 200. In the embodiment described above, the second printing service system 200 acquires the printing data from the first printing service system 100, and the relay server 300 may acquire the printing data from the first printing service system 100 and transmit the printing data to the second printing service system 200. In the embodiment described above, an example in which a general user registers a personal printer is described, but an administrator may register the personal printer for the general user on behalf of the general user.

In the above-described example, the program includes an instruction group (or a software code) for causing the computer to perform one or more functions described in the embodiment when the program is read by the computer. The program may be stored in a non-transitory computer-readable medium or a tangible storage medium. Examples of a computer-readable medium or a tangible storage medium include, but are not limited to, a random-access memory (RAM), a read-only memory (ROM), a flash memory, a solid-state drive (SSD), other memory techniques, a CD-ROM, a digital versatile disk (DVD), a Blu-ray (registered trademark) disk, other optical disk storage, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

Although the present disclosure is described with reference to the above embodiment, the present disclosure is not limited only to the configuration of the above embodiment, and it goes without saying that the present disclosure includes various variations, modifications, and combinations that can be made by those skilled in the art within the scope of the disclosure in the claims of the present application.

What is claimed is:

1. A relay server coupled to a first printing service system and a second printing service system coupled to an image forming device, the relay server comprising:
a registration reception unit configured to acquire a registration instruction for the image forming device;
an information acquisition unit configured to acquire information on the image forming device from the second printing service system when the registration instruction is acquired; and
a registration setting unit configured to register the image forming device in the first printing service system using the information on the image forming device acquired from the second printing service system, and to instruct the first printing service system to create client automatic setting information for registering the image forming device in a terminal device of a user.

2. The relay server according to claim 1, further comprising:
a storage configured to store qualification information about a first user having first authority, wherein
the registration reception unit acquires a registration instruction for the image forming device from a second user having second authority, which is authority more limited than the first authority, and
the registration setting unit uses the qualification information on the first user stored in the storage when registering the image forming device in the first printing service system.

3. The relay server according to claim 1, wherein
the registration setting unit is configured to transmit, to the first printing service system, an instruction to delete the client automatic setting information stored in the first printing service system.

4. The relay server according to claim 3, wherein
the registration setting unit sets a schedule such that the client automatic setting information stored in the first printing service system is deleted after a certain period of time elapses, and transmits, to the first printing service system, an instruction to delete the client automatic setting information based on the schedule.

5. The relay server according to claim 3, wherein
the registration setting unit is configured to be capable of acquiring, from the first printing service system, identification information for specifying the client automatic setting information created by the first printing service system, and
the registration setting unit transmits the identification information when transmitting an instruction to delete the client automatic setting information to the first printing service system.

6. The relay server according to claim 1, wherein
the client automatic setting information is information used for registering the image forming device in the terminal device when the user logs in the terminal device.

7. The relay server according to claim 6, wherein
the client automatic setting information includes access right information that defines a user who has access to the image forming device, and
the image forming device is registered in the terminal device when the access right information in the client automatic setting information includes a user who logs in the terminal device.

8. The relay server according to claim 6, wherein
the client automatic setting information further includes identification information for specifying the image forming device.

9. The relay server according to claim 1, wherein
the registration setting unit registers the image forming device in the first printing service system as a virtual device.

10. The relay server according to claim 1, wherein
the relay server is provided in the second printing service system.

11. A printing system comprising:
a first printing service system;
an image forming device;
a second printing service system coupled to the image forming device;
a terminal device coupled to the first printing service system; and
a relay server coupled to the first printing service system and the second printing service system, wherein
the relay server includes
a registration reception unit configured to acquire a registration instruction for the image forming device,
an information acquisition unit configured to acquire information on the image forming device from the second printing service system when the registration instruction is acquired, and
a registration setting unit configured to register the image forming device in the first printing service system using the information on the image forming device acquired from the second printing service system, and to instruct the first printing service system to create client automatic setting information for registering the image forming device in the terminal device,
the first printing service system transmits the client automatic setting information to the terminal device in response to a request from the terminal device, and
the terminal device registers the image forming device in the terminal device using the client automatic setting information.

12. The printing system according to claim 11, wherein
the client automatic setting information includes access right information that defines a user who has access to the image forming device, and
the terminal device acquires the client automatic setting information from the first printing service system when a user logs in the terminal device, and registers the image forming device in the terminal device when the user who logs in the terminal device is in the access right information in the client automatic setting information.

13. The printing system according to claim 11, wherein
the first printing service system acquires printing data from the terminal device,
the relay server further includes a printing controller configured to relay, between the first printing service system and the second printing service system, information on a printing job for printing the printing data, and
the image forming device executes printing of the printing data based on the information on the printing job relayed by the relay server.

14. An information processing method comprising:
by a relay server coupled to a first printing service system and a second printing service system coupled to an image forming device,
acquiring a registration instruction for the image forming device;
acquiring information on the image forming device from the second printing service system when the registration instruction is acquired; and
registering the image forming device in the first printing service system using the information on the image forming device acquired from the second printing service system, and instructing the first printing service system to create client automatic setting information for registering the image forming device in a terminal device of a user.

15. A non-transitory computer-readable storage medium storing a program, the program causing a computer of a relay server coupled to a first printing service system and a second printing service system coupled to an image forming device to execute operations comprising:
acquiring a registration instruction for the image forming device;
acquiring information on the image forming device from the second printing service system when the registration instruction is acquired; and
registering the image forming device in the first printing service system using the information on the image forming device acquired from the second printing service system, and instructing the first printing service system to create client automatic setting information for registering the image forming device in a terminal device of a user.
